(19) United States
(12) Patent Application Publication
(10) Pub. No.: US 2025/0286612 A1
(43) Pub. Date: Sep. 11, 2025

(54) NON-TERRESTRIAL NETWORK MISSION PLANNING AND SCHEDULING

(71) Applicant: Intel Corporation, Santa Clara, CA (US)

(72) Inventors: Stephen T. Palermo, Chandler, AZ (US); Parker Lischwe, Phoenix, AZ (US)

(21) Appl. No.: 19/217,685

(22) Filed: May 23, 2025

Related U.S. Application Data
(60) Provisional application No. 63/651,797, filed on May 24, 2024.

(51) Int. Cl. H04B 7/185

(52) U.S. Cl. CPC H04B 7/18532; H04B 7/18513; H04B 7/18519

(57) ABSTRACT

Various approaches for performing and coordinating mission planning and scheduling with non-terrestrial network connections are discussed. An example technique for terminal connectivity with a satellite non-terrestrial network (NTN), includes: identifying an on-Earth location of a terrestrial terminal to establish a data link via a satellite NTN; identifying respective times that the satellite vehicles are within line-of-sight to provide network connectivity for the data link; determining payload capabilities of the satellite vehicles that support varying types of connectivity and data processing within the satellite NTN; generating data link reservations for the satellite vehicles to provide the network connectivity to the terrestrial terminal during the respective times, based on the payload capabilities; and communicating the data link reservations to the respective satellite vehicles, to reserve a portion of an uplink and a downlink of the satellite NTN to provide the network connectivity.

### PRIORITY CLAIM

This application claims the benefit of priority to U.S. Provisional Patent Application No. 63/651,797, filed May 24, 2024, and titled “NON-TERRESTRIAL NETWORK MISSION PLANNING AND SCHEDULING”, which is incorporated herein by reference in its entirety.

### BACKGROUND

A variety of satellite communication networks have been deployed that enable many types of communication use cases. For instance, Low Earth Orbit (LEO) satellite constellations are being increasingly deployed to provide data and mobile phone connectivity in areas where on-earth network communications (e.g., terrestrial wired or cellular links) are not available. When a large constellation of satellites is deployed, continuous or near-continuous coverage can be achieved in a geographic area. However, there are many complexities in coordinating satellite network coverage due to the rapid orbits used by LEO satellites, the multiple types and orbits of satellites, satellite constellations, and satellite network providers, and a variety of on-earth restrictions applied to satellite communications (such as restrictions intended to prevent interference with existing communication networks or sensitive electronic equipment).

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates network connectivity in non-terrestrial (satellite) and terrestrial (e.g., mobile cellular network) settings, according to an example;

FIGS. 2A and 2B depict maps showing non-terrestrial network coverage and connectivity among various geographic areas, according to an example;

FIGS. 3A to 3D depict various connection scenarios for mission planning and scheduling for connectivity in a non-terrestrial network, according to an example;

FIGS. 4A to 4D depict flowcharts of operations for determining mission planning and scheduling for connectivity in a non-terrestrial network, according to an example;

FIG. 5 depicts a data flow of operations for implementing mission planning and scheduling in connection with artificial intelligence (AI) modeling, according to an example;

FIG. 6 depicts a flowchart of a method for coordinating mission planning and scheduling for network connectivity via a satellite constellation, according to an example;

FIG. 7A illustrates a scenario of geographic satellite connectivity from low-earth orbit satellite communication networks, according to an example;

FIGS. 7B and 7C illustrate terrestrial-based, LEO satellite-enabled edge processing arrangements, according to an example;

FIG. 8 illustrates network uplinks and downlinks provided via a non-terrestrial network, according to an example;

FIGS. 9, 10, and 11 illustrate respective configurations of non-terrestrial and 5G network architectures, according to an example;

FIG. 12 illustrates an implementation of exclusion zones for a non-terrestrial communication network, according to an example;

FIG. 13 illustrates various types of exclusion zones implemented for a non-terrestrial communication network, according to an example;

FIG. 14 illustrates a flowchart of an example method of implementing exclusion zones for inter-satellite communications in a non-terrestrial communication network, according to an example;

FIGS. 15A, 15B, 15C, and 15D illustrate views of exclusion zones implemented by a non-terrestrial communication network, according to an example;

FIG. 16A illustrates an overview of example components deployed at a compute node system, according to an example;

FIG. 16B illustrates a further overview of example components within a computing device, according to an example; and

FIG. 17 illustrates a software distribution platform to distribute software instructions and derivatives, according to an example.

### DETAILED DESCRIPTION

The following discussion relates to various aspects of Mission Planning and Scheduling (MPS) issues related to Low Earth Orbit (LEO) non-terrestrial network (NTN) satellite constellations, including for satellite vehicles (SVs) that contain different payloads (e.g., different satellite processing and networking capabilities). Specifically, the following techniques evaluate known constellation orbital information with satellite payload capabilities to schedule and reserve resources for various networking connections and scenarios. Such scheduling is needed to effectively support on-demand and/or autonomous satellite constellations supporting both direct attach NTN UEs/Terminals or UEs/Terminals that are attached via on-Earth ground station gateways.

Coordinating MPS for individual connections is particularly important and relevant to newer satellite deployments, as SVs and constellations increasingly offer different types and flavors of payload processing and connectivity capabilities. Because newer and older satellite vehicles—and different versions of hardware, firmware, and software capabilities—co-exist in the same constellation, advanced capabilities are needed to plan and adapt for the use of different communication scenarios.

The following introduces on-demand MPS processes that can be used with many types of existing LEO constellations and configurations. The scheduling for such LEO constellations may originate on Earth, or may be coordinated with future in-orbit scheduling processing using a higher orbit satellite such as a geosynchronous orbit satellite or data center. Such scheduling may be used to support a variety of data connections and use cases, including in scenarios where the ground station is mobile (like a cruise or cargo ship), or where there are a mix of SV versions/capabilities for different constellations (such as a first version of a SV in a constellation that does not support UE direct access, versus a second version of the SV that supports UE direct access).

Further, when applied in LEO polar or inclined constellations, advanced MPS techniques can be used to identify line-of-sight beam-patterns at both UE/User Terminals and Ground Station, to select and schedule the appropriate contact satellite(s) containing the payloads necessary for direct attach, bent-pipe, regenerative, or transparent connection architectures. Satellite angle of elevation, exclusion zones, and inter-satellite links are also coordinated with MPS operations to ensure correct data flow and control for a variety of network connection paths that involve satellite constellations.

An MPS artificial intelligence (AI) model can also be used to make or adjust scheduling decisions, including decisions based on measurements related to signal quality and fault detection. In an example, the AI model can be provided from a variety of Deep Neural Networks trained and deployed to optimize MPS decision making through the continuous processing of continuous and discrete parameters such as signal quality, power, downlink success, and space and time. These neural networks can be MLP (multilayer perceptron) based and trained using deep reinforcement learning algorithms that assign rewards to actions made by the policy network. The rewards represent the change in the system caused by this action that was originally derived by the model's policy. These reward signals are meant to drive a policy that maps system states to actions in order to gradually improve the long-term reward. For instance, a representative system state can be defined by the resources allocated, signal quality, and/or complete failure in downlink connection. If the model chose to recommend an action of connecting one GS to one SV and the downlink connection was successful without overuse of resources (bandwidth, power, etc.) the reward would reinforce the model's policy by increasing the probability of this “good” action while decreasing the probability of bad actions.

### Overview of Non-Terrestrial Network Configurations

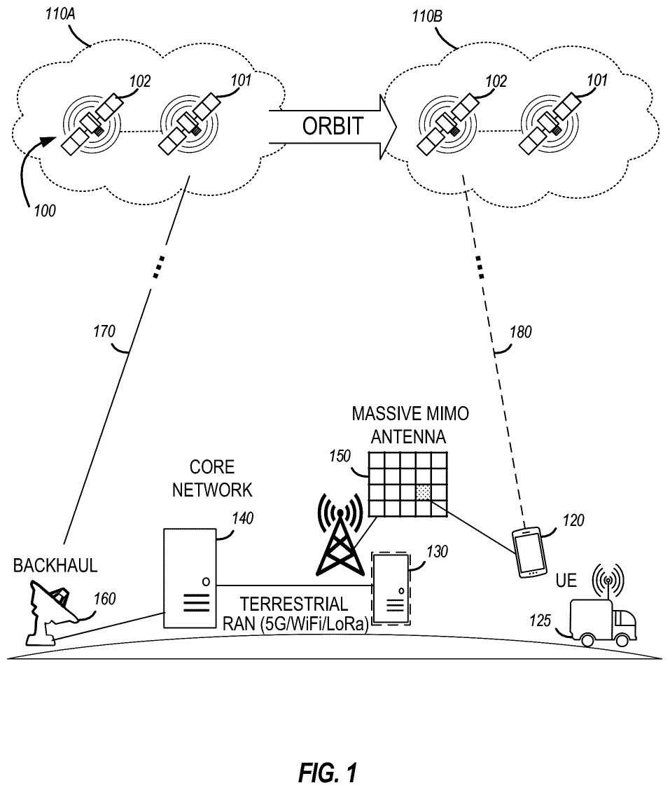

FIG. 1 illustrates network connectivity in non-terrestrial (satellite) and terrestrial (e.g., mobile cellular network) settings, according to an example. As shown, a satellite constellation 100 (the constellation depicted in FIG. 1 at orbital positions 110A and 110B) may include multiple satellite vehicles (SVs) 101, 102, which are connected to each other and to one or more terrestrial networks. The individual satellites in the constellation 100 (each, an SV) conduct an orbit around the Earth, at an orbital speed that increases as the SV is closer to Earth. LEO constellations are generally considered to include SVs that orbit at an altitude between 160 and 1000 km; at this altitude, each SV orbits the Earth about every 90 to 120 minutes.

The constellation 100 includes individual SVs 101, 102 (and numerous other SVs not shown), and uses multiple SVs to provide communications coverage to a geographic area on Earth. The constellation 100 may also coordinate with other satellite constellations (not shown), and with terrestrial-based networks, to selectively provide connectivity and services for individual devices (user equipment) or terrestrial network systems (network equipment).

In this example, the satellite constellation 100 is connected via a satellite link 170 to a backhaul network 160, which is in turn connected to a 5G core network 140. The 5G core network 140 is used to support 5G communication operations with the satellite network and at a terrestrial 5G radio access network (RAN) 130. For instance, the 5G core network 140 may be located in a remote location and use the satellite constellation 100 as the exclusive mechanism to reach wide area networks and the Internet. In other scenarios, the 5G core network 140 may use the satellite constellation 100 as a redundant link to access the wide area networks and the Internet; in still other scenarios, the 5G core network 140 may use the satellite constellation 100 as an alternate path to access the wide area networks and the Internet (e.g., to communicate with networks on other continents).

FIG. 1 additionally depicts the use of the terrestrial 5G RAN 130, to provide radio connectivity to a user equipment (UE) such as UE 120 smartphone user device or an on-ground vehicle UE 125 via a massive MIMO antenna 150. It will be understood that a variety of 5G and other network communication components and units are not depicted in FIG. 1 for purposes of simplicity. In some examples, each UE 120 or 125 also may have its own satellite connectivity hardware (e.g., receiver circuitry and antenna), to directly connect with the satellite constellation 100 via satellite link 180. Although a 5G network setting is depicted and discussed at length in the following sections, it will be apparent that other variations of 3GPP, O-RAN, and other network specifications may also be applicable.

Other permutations (not shown) may involve a direct connection of the 5G RAN 130 to the satellite constellation 100 (e.g., with the 5G core network 140 accessible over a satellite link); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost, and security, and geographic or geopolitical considerations, and the like.

With these basic entities in mind, and with the changing compositions of mobile users and in-orbit satellites, the following techniques describe ways in which terrestrial and satellite networks can be extended and deployed for various communication and edge computing scenarios.

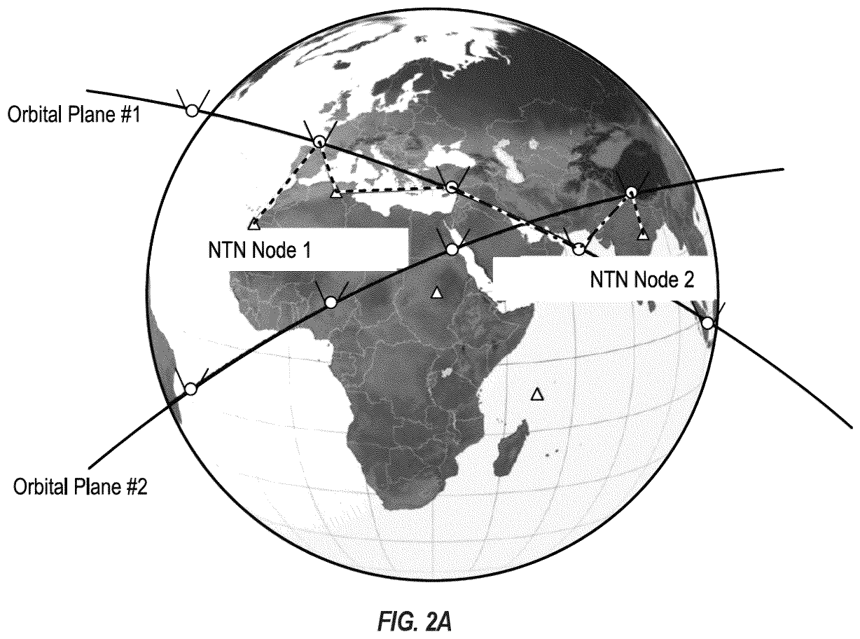

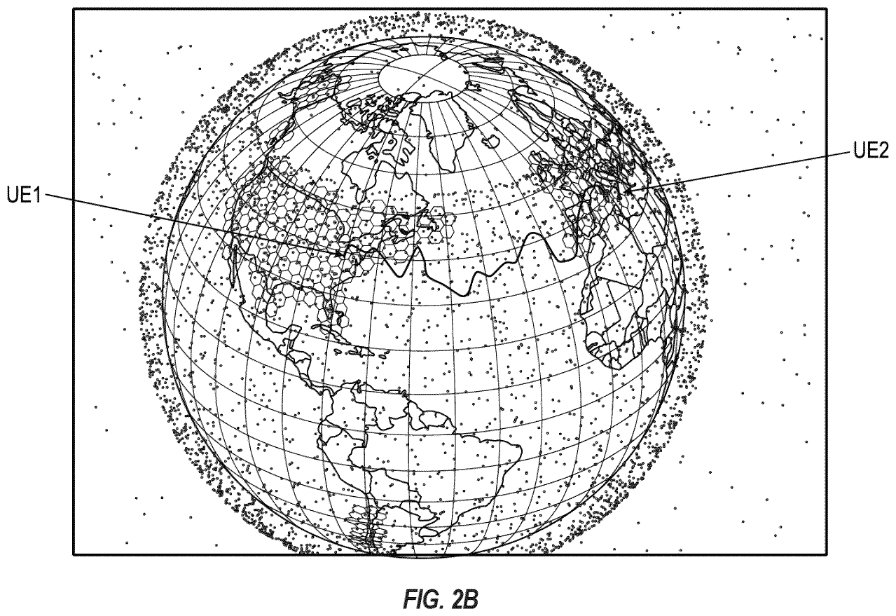

FIG. 2A depicts a geographical map showing how an NTN network or networks may include multiple constellations and orbital planes that provide service to multiple geographic areas. Accordingly, a variety of interference concerns may be raised from ground coverage among many different countries, when space-originating broadcasts are provided from different constellations, different satellite types, and potentially different service providers, from non-terrestrial networks.

FIG. 2B depicts a connection scenario involving connectivity from a first UE (UE 1) to a second UE (UE 2) via a complex pathway of non-terrestrial network connections. For instance, the first UE is located on a first continent, and connects to a first SV of a first satellite constellation. The second UE is located on a second continent and connects to a second SV of a second satellite constellation. Establishing connectivity between the first UE and the second UE involves a number of connections, whether in-space (with inter-satellite links among SVs), to and from the SVs, and via ground stations used for coverage and connectivity with the UEs and the satellite NTN.

Due to complex pathways and the number of connections used between two on-Earth endpoints, a significant technical issue may arise during overall LEO scheduling when connecting to and using SVs with different payload capabilities. As used herein, such “payload capabilities” refers to the particular combination of hardware, software, and firmware provided on an individual communication satellite vehicle, including functional capabilities provided by hardware such as various instruments, transponders, antennas, signal processing equipment, and computing elements for transmitting and receiving data in connection with a communication scenario.

### Mission Planning and Scheduling in Non-Terrestrial Network Configurations

The following introduces approaches for the improvement of MPS operations, in particular to improve connectivity between terrestrial equipment (e.g., ground stations, UEs, etc.) and the satellite NTN SVs which may have different payload capabilities. In some examples, these MPS operations can be used to coordinate satellite “direct attach” (DA) connections (also called “direct-to-handset” or “direct-to-cell” connections) where UEs such as smartphones directly connect to a modem onboard the satellite vehicle that acts like a cellphone tower in space. The following also introduces coordination of exclusion zones with MPS, and the use of advanced logic (e.g., provided by an AI Model) for improving connection routing and fault avoidance with MPS.

An example MPS procedure may include the following. First, a determination is made to assess the need for a data link between devices (e.g., as shown in FIG. 2A), including at what time and for how long. This data link is often referred to as a “contact”. Next, a determination is made to assess which earth station(s) will be used for the data link. Then, before the data link is used, MPS will load a flight plan that will establish and reserve resources for the data link, provided via a secondary or telemetry tracking and command (TTAC or TTC) feeder link.

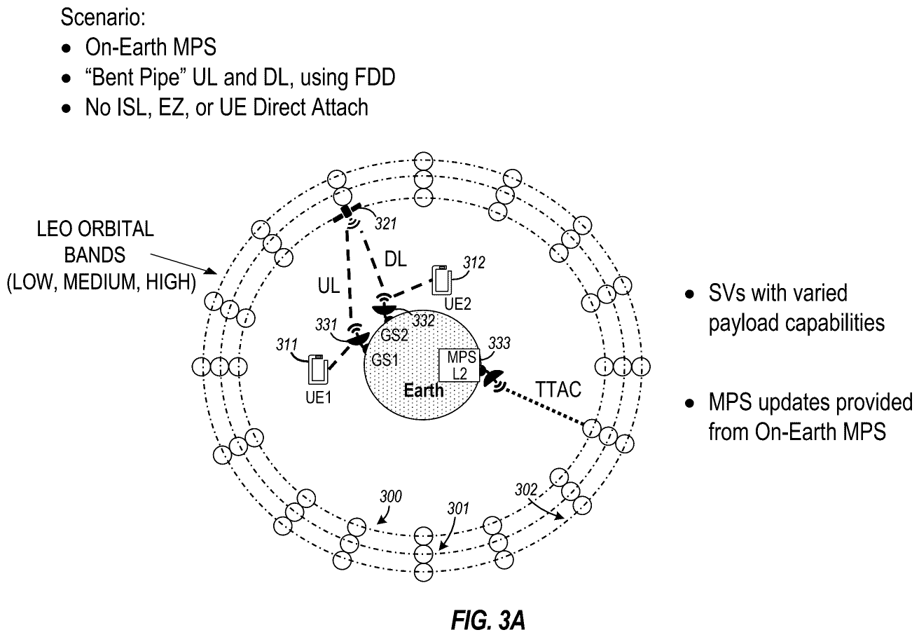

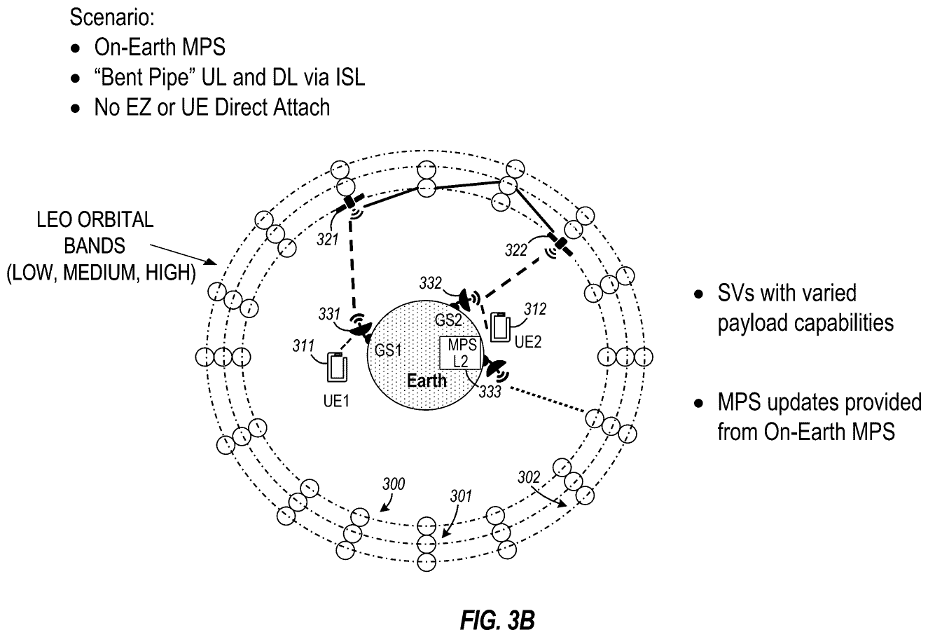

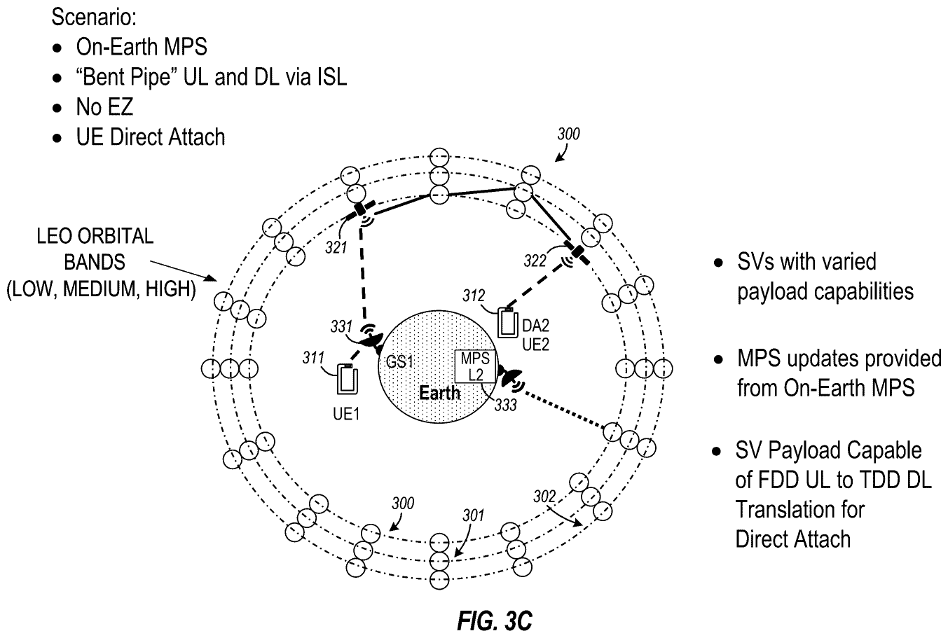

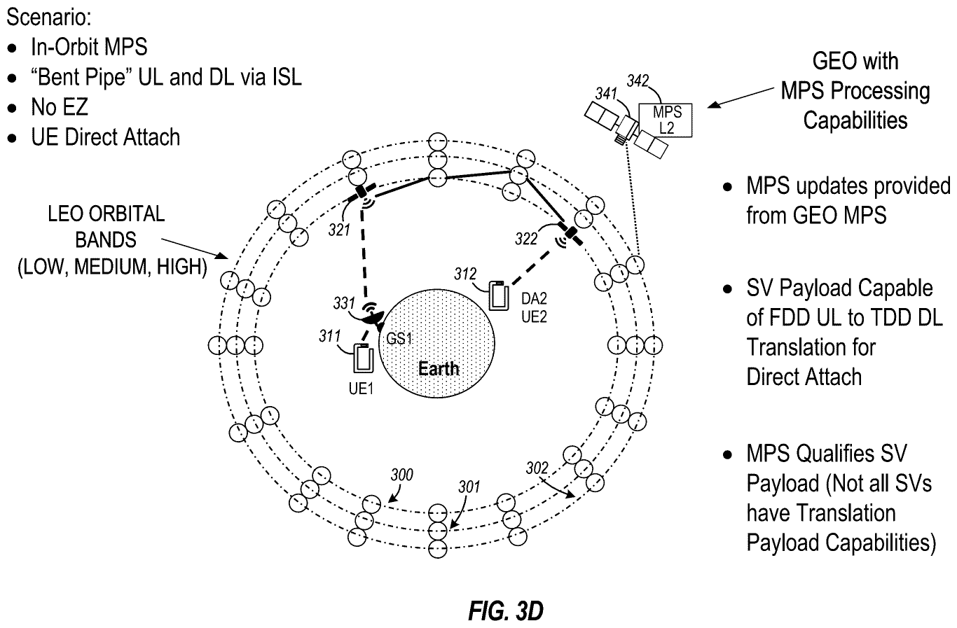

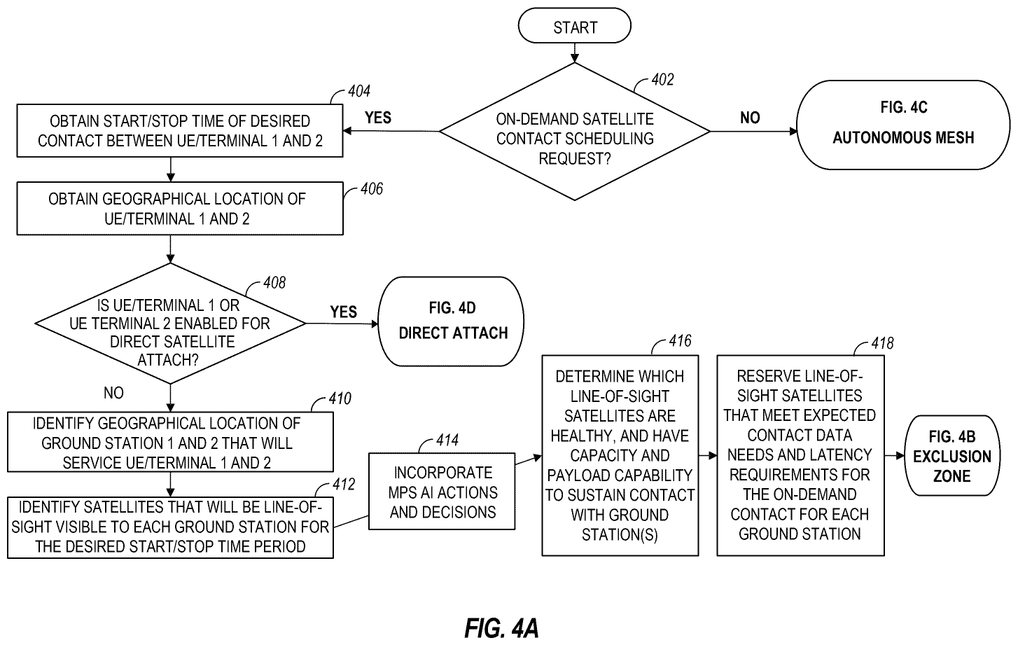

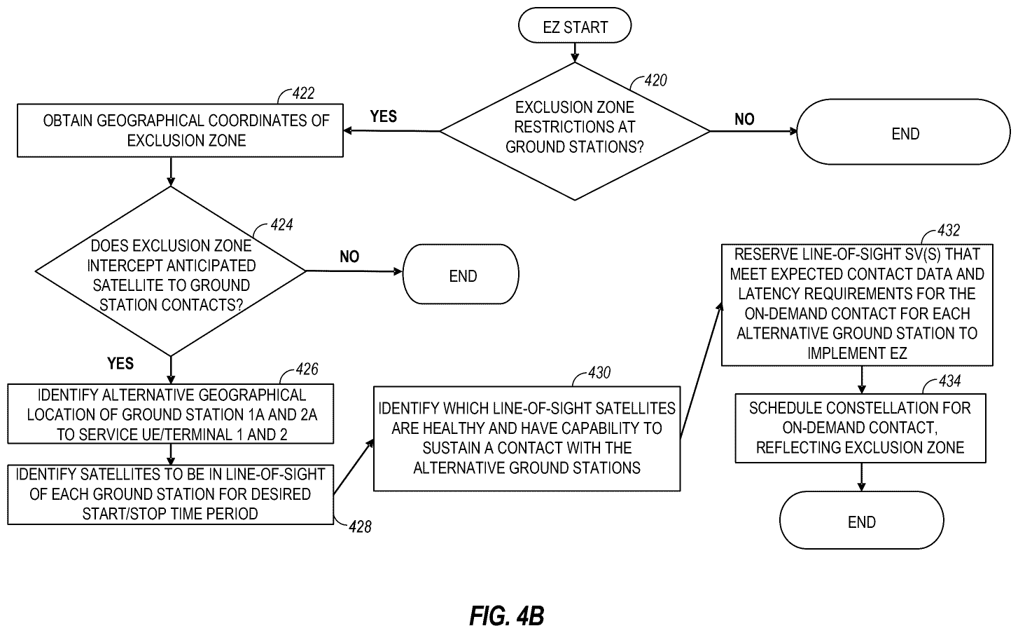

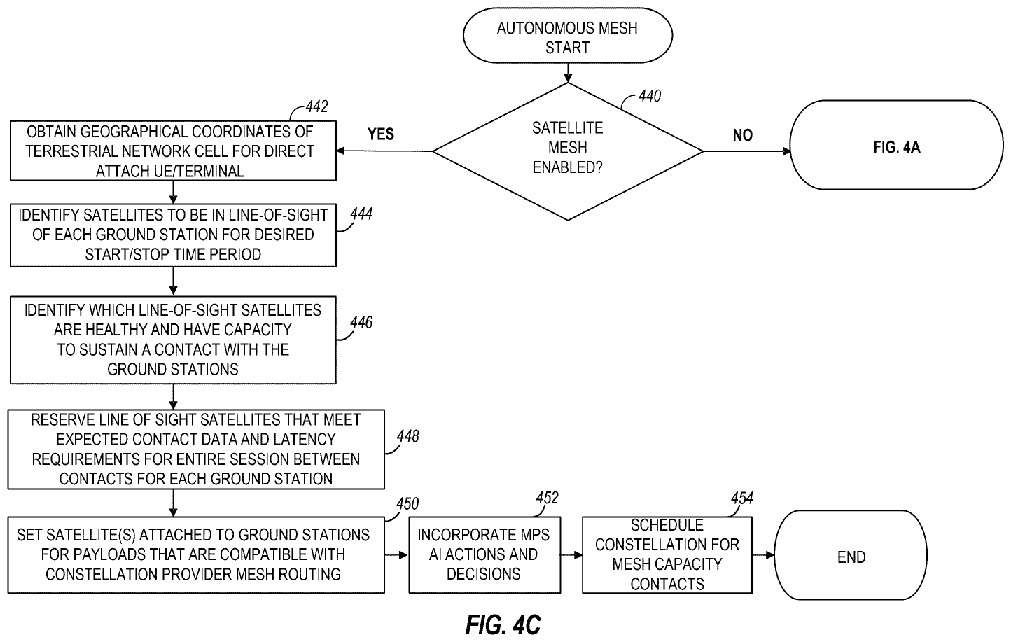

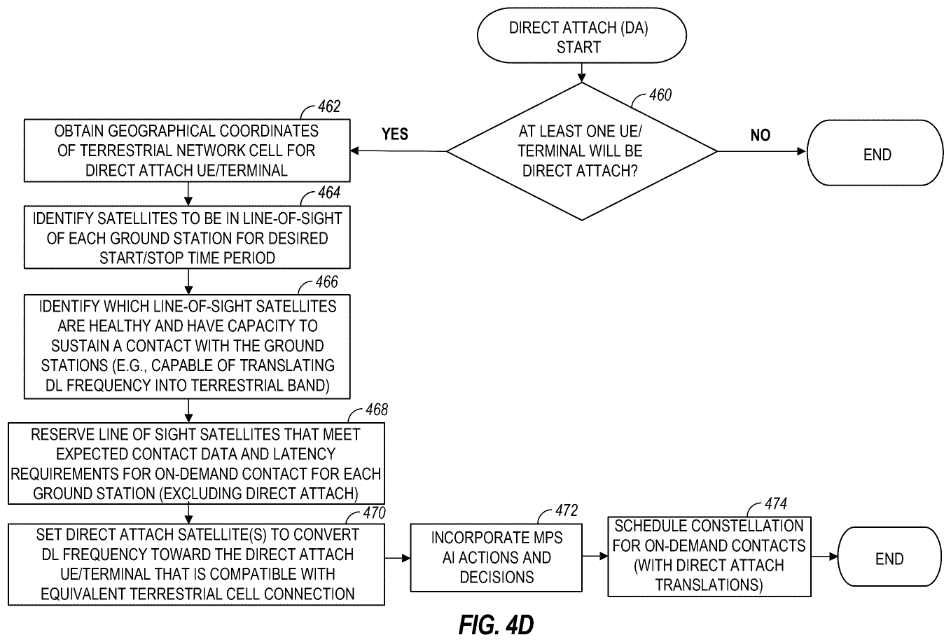

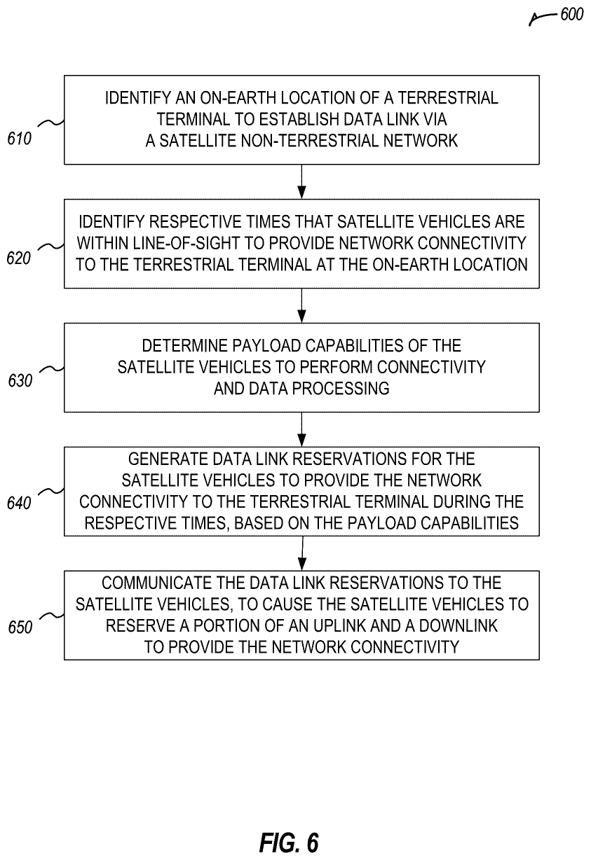

An example flowchart of establishing and reserving resources for a data link is detailed below in FIG. 6 and in the scenarios of FIGS. 3A to 4D. For example, an example scenario may include identifying the satellites in the constellation that will be flying over the earth stations, which are endpoints that need to be connected to sustain a data link for the contact. However, as shown in FIG. 2A, the data link may be threaded throughout the constellation in and out of a constellation's intersatellite links, based on a routing algorithm. A routing algorithm can change over time and may be proprietary to a particular constellation.

Using the ground station fly-over list, the satellites are checked to ensure that they include supported hardware, firmware, and software versions. If the satellites are not supported to establish the data link, then they may be skipped for use (such as in a scenario where only certain versions of satellites are approved for use). Inter-satellite links (ISL) can be capacity reserved for a specific time duration (e.g., via fore/aft/right/left ISL antennas), and the routing algorithm can determine which ISLs on each satellite in the data link route to use for how long. As noted above, this information is important for MPS and is then uploaded via the TTAC, ahead of any data link usage.

In many examples, MPS procedures can originate from Earth. However, in other examples, the MPS procedures can be performed in-orbit either by a geosynchronous satellite or another non-Earth-based node that can communicate to the constellation via a TTAC link. Exclusion and interference coordination zones can also be factored in to ensure that the data link does not result in preventable interference.

FIGS. 3A to 3D depict various connection scenarios involving ground stations and UEs that coordinate MPS for connectivity from a non-terrestrial network. First, FIG. 3A depicts a connection scenario for MPS determined at an on-earth location (MPS L2 333). The MPS data is determined based on orbital angular momentum calculations and is provided to the various constellations via MPS updates (from MPS L2 333). For instance, the MPS data may be communicated to one or multiple satellite constellations (e.g., constellation 300 in a low orbital band, constellation 301 in a medium orbital band, or constellation 302 in a high orbital band) via telemetry tracking and command (TTAC or TTC) communication services.

In the scenario of FIG. 3A, the SVs are arranged in respective constellations, such as in a first second, and third orbital band of constellations. These orbital bands may correspond to “low”, “medium”, and “high” orbital ranges in some examples, or different constellations/levels coordinated within a same orbital range. The SVs among the respective constellations will have varied payload capabilities and capacities to perform different communication operations.

The scenario depicted in FIG. 3A does not depict inter-satellite links, exclusion zones, or direct access to the UE. Here, the SV 321 may be selected to establish an uplink/downlink data connection between ground stations GS1 331 and GS2 332, to facilitate the particular data transmission sent between UE1 311 and UE2 312. This SV 321 may have a payload that is capable of FDD (frequency division duplex) frequency translation. If the MPS is aware of this capability, the connections with the SV 321 can be scheduled and coordinated to use this capability.

To enable UE1 311 to connect to UE2 312, the UE1 311 performs an uplink from a network connected to the first ground station GS1 331 to the SV 321. The satellite SV 321, in a simplest example, then performs a downlink to the second ground station GS2 332 that in turn is connected to the UE2 312. In this scenario, the SV 321 provides a “bent-pipe” uplink to downlink FDD translation. This capability may be scheduled for the short amount of time that the SV 321 is available (e.g., line of sight to one or both) to GS1 331 and GS2 332.

FIG. 3B depicts a further connection scenario for MPS determined at an on-earth location (MPS L2 333), and the use of inter-satellite links to connect GS1 331 with GS2 332. Here, some of the SV payloads are capable of performing FDD frequency translation and switching, and the MPS L2 333 is aware of this capability. This allows a connection from the GS1 331 to the SV 321, then via ISL connections to the SV 322, and then back to the GS2 332. The depicted connections among the low-orbital band constellation include use of inter-satellite links among the constellation in the same orbital band, and the use of inter-satellite links to another constellation in another orbital band (e.g., from low orbital band constellation 300, to medium orbital band constellation 301, back to low orbital band constellation 300).

FIG. 3C depicts a further connection scenario for MPS determined at an on-earth location (MPS L2 333), where inter-satellite links are used. In this scenario, however, UE2 312 communicates via a direct attach connection to a satellite, such as SV 322. The SV payload at SV 322 is capable of FDD UL to TDD DL translation for direct attach functionality. The MPS qualifies the SV's payload, because not all SVs have translation payloads or capabilities.

FIG. 3D depicts a further connection scenario for MPS determined at non-terrestrial location (MPS L2 342, located in-orbit at an SV 341) where inter-satellite links are used. In this scenario, UE2 312 also provides a direct attach connection to a satellite, such as SV 322. The MPS L2 342, located in-orbit, may be coordinated from a geostationary satellite with MPS processing capabilities, to provide TTAC OAM with MPS updates to multiple satellite constellations.

As will be understood, a variety of paths may be identified and scheduled with MPS. These may include: a primary path; a failover path; a “hot” path standby; an earth feeder link rerouting path; a multi-orbit top/bottom routing path; a rerouting path, determined based on cost, established among terrestrial/non terrestrial connections; and a variety of secondary or tertiary paths. MPS may also coordinate direct attach capabilities, all while considering the requirements of exclusion zones and relevant regulations/restrictions.

FIG. 4A depicts a flowchart of a method for implementing mission planning and scheduling between two on-Earth UEs or terminals, labeled as UE/Terminal 1 and UE/Terminal 2. Here, in response to an on-demand satellite contact scheduling request at determination 402, information regarding the contact between UE terminals is obtained, such as to obtain the start/stop time of the desired contact at operation 404, and to obtain the geographic location of the UEs/terminals at operation 406. If the scheduling request is not on-demand at determination 402, then operations as depicted in FIG. 4C can be used to provide scheduling in an autonomous mesh scenario.

If either or both of the UEs/terminals are enabled for direct satellite attach at determination 408, then operations as depicted in FIG. 4D can provide direct attach connectivity for the particular UE/terminal. If the particular UE/terminal is not enabled for direct satellite attach at determination 408, then additional operations are performed to identify information regarding geographic location at operation 410 and to identify line-of-sight coverage at operation 412. Additionally, AI-determined MPS actions and decisions may be provided, based on AI data analysis at operation 414, determination of capacity and payload capability at operation 416, reservation availability and data requirements at operation 418, and the like. This may be followed by the use of an exclusion zone, depicted further in FIG. 4B. For operation 414, the outputs of operations 410 and 412 (e.g., locations of GS1 GS2, and corresponding line-of-sight satellite states) can be provided as inputs to a neural network (or multiple jointly trained NNs). This neural network, for example, may generate a probability distribution over all potential actions can be sampled from, which provides real time resource-aware decisions that can balance rewards such as GS/SV pair selection, power level, etc.

In some examples, the evaluation of which line-of-sight satellites are available for connection can depend on a predetermined elevation threshold and a satellite state. Additionally, the evaluation of which satellites have payload capability may be dependent on particular SV payload configurations. Some SV payloads in a constellation may be less capable than others, such as not having direct attach FDD-TDD translation capabilities, or not having inter-satellite link (ISL) switching capabilities. The capabilities may also be dependent on use of a software-defined radio, such as a radio that uses a different spectrum.

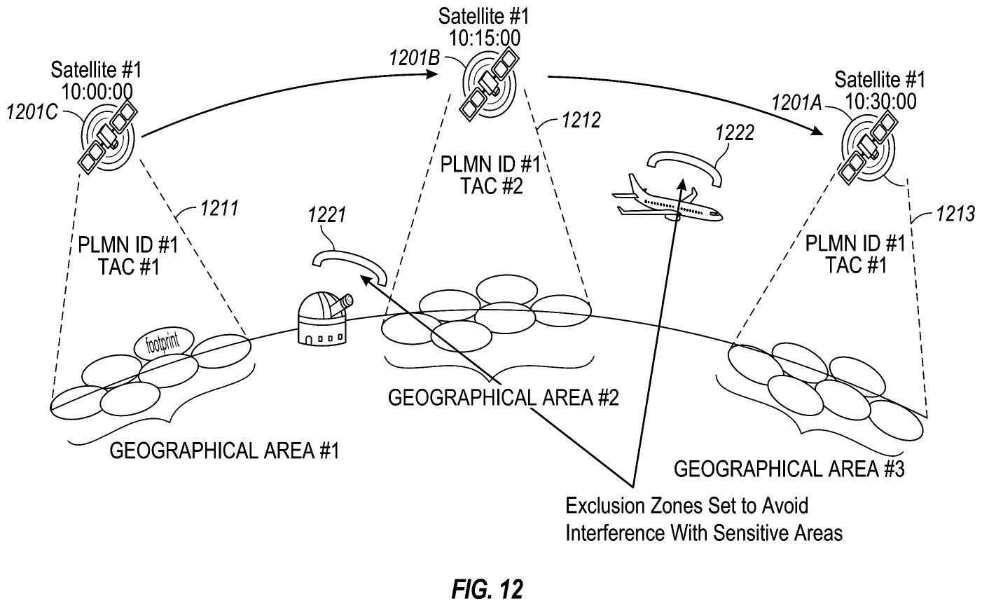

FIG. 4B depicts a flowchart of a method for implementing mission planning and scheduling in connection with an exclusion zone. Additional implementation examples of an exclusion zone are provided below with reference to FIG. 12 to FIG. 15D. In FIG. 4B, in response to exclusion zone restrictions at ground stations at determination 420, geographical coordinates of the exclusion zone are obtained or identified at operation 422. In response to exclusion zone interception of the expected satellite with ground station contacts at determination 424, alternative geographic locations and satellites are identified at operation 426. This can be used to identify whether there are paths to alternative ground stations with capacity and capability at operation 430; and then to reserve line-of-sight satellites at operation 432 and schedule on-demand contacts at operation 434 based on these paths to alternative ground stations.

FIG. 4C depicts a flowchart of a method for implementing mission planning and scheduling in connection with an autonomous mesh. In FIG. 4C, in response to the satellite mesh being enabled at determination 440, information is obtained or evaluated at operations 442, 444, and 446 regarding geographical coordinates and line-of-sight satellites applicable to contact with the ground stations. The satellite and ground station resources can then be reserved at operation 448 and adapted at operation 450 based on mesh routing. AI-based routing actions and decisions, such as with use of a resource-aware neural network or an optimized policy network, may be incorporated into the scheduling at operation 452. In further examples, more entities in the satellite constellation can be scheduled and coordinated at operation 454 for capability controls, based on this mesh routing.

FIG. 4D depicts a flowchart of a method for implementing mission planning and scheduling in connection with UE direct attach (DA) connections. In FIG. 4D, in response to at least one UE/terminal being designated to perform a direct attach at determination 460, information is obtained at operations 462, 464, and 466 regarding geographical coordinates and line-of-sight satellites applicable to contact with the UE(s)/terminals and the ground stations. The satellite and ground station resources can then be reserved at operation 468, and satellites can be configured to perform direct attach operations at operation 470. A direct attach-capable satellite in this example is capable of translating the DL frequency into a terrestrial band.

AI-based routing actions and decisions may be incorporated into the scheduling at operation 472. Additionally, more entities in the constellation can be scheduled and coordinated at operation 474 for capability controls, based on the on-demand contacts and direct attach translations. Because different inputs and outputs are used, the AI evaluations in operation 472 may differ from those in operations 414 or 452. As will be understood, each of the AI models used in operations 414, 452, 472 may be trained on the environments and actions that would typically be encountered at inference, including with separate training and deployment of models.

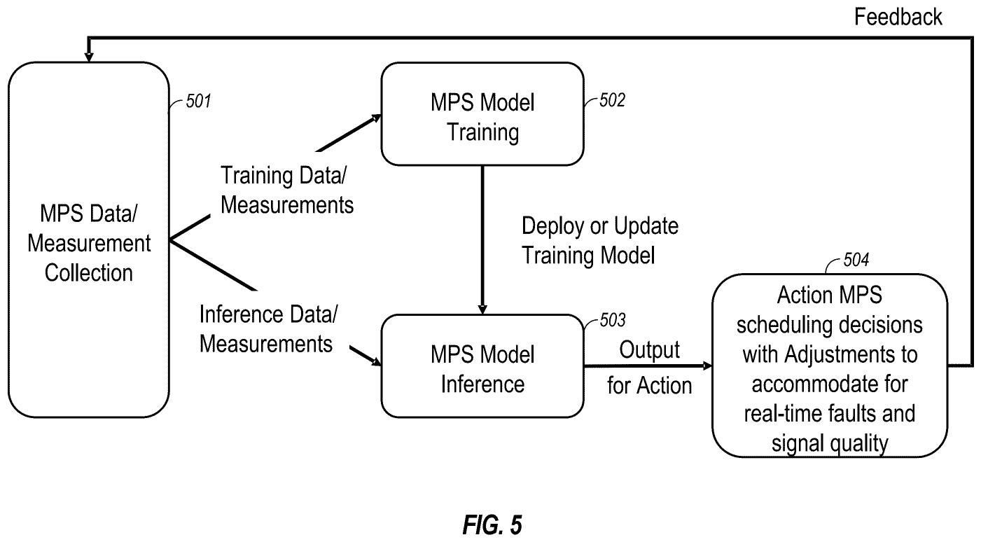

FIG. 5 depicts a data flow of operations for implementing mission planning and scheduling in connection with artificial intelligence (AI) modeling, including training and inferencing of an AI model to assist with MPS action and decision making as discussed herein. As shown, MPS data and measurements are collected at operation 501, used for MPS model training at operation 502, and used for MPS model inferencing at operation 503. The use of the MPS model inferencing can, among other actions, assist with scheduling decisions and adjustments to accommodate real-time faults and signal quality.

The use of MPS model inferencing may include using AI for MPS (e.g., using AI inferencing to help identify scheduling adjustments ahead of time) and AI during MPS (e.g., using real-time adaptation of connections based on AI inferences, including how to change connection characteristics such as modulation, coding, etc.).

Example implementations of AI for MPS include predictive neural networks for MPS, which make predictions of future bottlenecks and resource constraints based on historical data and their outcomes. A predictive neural network can use a sequential architecture such as recurrent neural network (RNN), Long Short-Term Memory (LSTM), or Transformer architectures. Example implementations of AI during MPS include reinforcement learning in neural networks during MPS. AI during MPS can be used to guide decision making for discrete and continuous degrees of freedom. This model architecture can be multilayer perceptron (MLP) neural network-based and can be trained using reinforcement learning (RL) algorithms to optimize resource allocation through interaction with an environment that changes based on an action made by the policy network. A well-defined reward function can be used to adjust model behavior towards a long-term reward.

MPS model inferencing may be performed on-Earth using a computing device (e.g., an edge device, or a data center), or such inferencing operations can be performed off-earth in scenarios where computation is moved onto a geosynchronous satellite or capable LEO satellite with specialized silicon.

As an example of AI during MPS, consider a scenario when an AI model is performing inferencing in real time, with results in a small number of milliseconds, on a localized ground station where the MPS is used to establish a data connection. If some adverse weather event (e.g., a hailstorm) arrives at the ground station, the FDD uses the AI model to determine a correction (e.g., a correction to the uplink or downlink data, based on the CSI information dropping below a clear weather scenario). For instance, the AI model may suggest changes to the modulation and coding scheme (MCS) to decrease bandwidth and to overcome the interference from the adverse weather. The AI model may be localized and provide detailed recommendations such as suggested changes on a per-slot communication to increase or decrease the modulation scheme, increase the power, etc. In further examples, localized ground stations may use personalized models, and ground stations may perform data collection and training on localized data for respective models. This training can occur at the MPS GS if hardware allows (e.g., with a large set of parallel GPUs) or trained in the cloud and then deployed locally.

The AI model may also be deployed in a scenario where the power on the SV is increased or decreased. The consumption of more power may decrease overall battery life until recharged, so an early handoff may be coordinated with the next SV that increases power ahead of time. The power recommendation may also be balanced and sensitive to site requirements and regulations, etc. Thus, an AI model can evaluate a variety of information to take actions such as coordinating an early handoff with the next SV while increasing power ahead of time, etc. This is possible when the AI model is optimized for avoiding faults and minimizing resources given similar environments and constraints to learn from.

Accordingly, AI-assisted MPS approaches can be used to resolve a variety of scheduling and communication issues related to use of specific satellites within a constellation that may have different payload capabilities. As noted above, some satellite vehicles might have different hardware, firmware, and software capabilities that impact the ability to use those satellites for specific contact scheduling scenarios, and some satellite constellations may be based exclusively in LEO orbits or coordinate with multi-orbit constellations including middle-earth orbit (MEO), geosynchronous orbit (GEO), or high-altitude platform (HAP) orbits. This is further complicated in settings where satellite hardware in such constellations may or may not support Inter Satellite Links (ISL) antennas that are directed in fore, aft, right, left, top, or bottom directions-especially for satellites that are in different orbital planes within inclined orbital planes.

Examples of data values communicated to configure the presently described MPS operations may include the following:

TABLE 1

| | |
|---|---|
| Scheduling Method | Scheduling Location: |
| (indicates location of scheduling) | SCH.EARTH, SCH_ORBIT |
| Al-Inference Method | AI-Inference Method: |
| (May include cascading and/or | AI.NONE; |
| parallel AI inference models, | AI.IMAGE_OBSTRUCTION; |
| performed at a scheduling location) | AI.LOWEST.COST; |
| | AI.LOWEST.LATENCY; |
| | AI.POWER.AI |
| Contact Timeframe | TimeFrame: |
| | CONTACT4.START_DATE/TIME, |
| | CONTACT4.END_DATE/TIME |
| In-orbit Elements | SV Status: |
| | e.g., SV1.ACTIVE, SV6.SPARE, |
| | SV88.MAINTENANCE SV Version: |
| | e.g., SV1.v1; SV3.v2 SV Capability: |
| | e.g., SV7.BENTPIPE; SV5.GS.ISL, |
| | SV7.DA, SV9.DA.ISL, |
| | SV5.ISL.F/A/R/L/T/B (Fore, Aft, |
| | Right, Left, Top, Bottom) |
| On-Earth Elements | GS Status: |
| Scheduling scenarios might include | e.g., GS56.ACTIVE.FIXED, |
| direct User Equipment (UE) to | GS9.ACTIVE.MOBILE, |
| satellite access, might include | GS4.ACTIVE.FIXED |
| Ground/Earth Station that support | GS Capability: |
| either User Control or Data Traffic, | e.g., GS44.USER.DATA, |
| might include Telemetry Tracking and | GS7.TTAC.DATA |
| Command (TTAC or TTC) only | GS Site Shielding: e.g., |
| traffic, and or a combination of all; | GS3.NO_SHIELD, GS6.SHIELD |
| Ground/Earth Stations may be fixed | |
| or Mobile. | |
| Exclusion/Coordination Zone (EZ) | EZ/CZ Restrictions: |
| Elements | e.g., EZ56.KEEPOUT.BLOCKALL, |
| An Exclusion Zone (EZ) may | EZ44.KEEPOUT.FREQ.Ku; |
| intercept a specific contact and may | CZ77.KEEPOUT.FREQ.n78 |
| restrict satellite beam radiation, | |
| frequency, patterns, and or reflection | |
| light pollution; A Coordination Zone | |
| (CZ) may intercept a specific contact | |
| and may enforce satellite beam | |
| antenna power, frequency, patterns | |
| that are deemed necessary for co- | |
| existence with Terrestrial Networking | |
| (TN) 4G/5G/6G operating during the | |
| contact; EZ and CZ interception is | |
| determined by comparing the location | |
| of the EZ/CZ with the anticipated | |
| orbital position of specific satellites | |
| that are necessary to sustain the | |
| contact. | |

For example, in a first example corresponding to FIG. 3A, the following data values can be used to specify MPS parameters:

TABLE 2

SCH.EARTH; SV1.ACTIVE; SV1.BENTPIPE; SV1.v1;
GS1.ACTIVE.FIXED; GS1.NO_SHIELD; GS1.USER_DATA;
GS2.ACTIVE.FIXED; GS3.NO_SHIELD; GS2.USER_DATA;
EZ.NONE;
AI.NONE; CONTACT.START.5.24.2024.16:01:50;
CONTACT.START.5.24.2024.16:04:50;
MPS: GS1 > SV1 > GS2 (UEs attached to gNB.GS1.Cell can
communicate with gNB.GS2.Cell during contact time);

Also, for example, in a second example corresponding to FIG. 3B, the following data values can be used to specify MPS parameters:

TABLE 3
SCH.EARTH; SV1.ACTIVE; SV1.ISL.F.A.R.L; SV1.v1;
SCH.EARTH; SV2.ACTIVE; SV2.ISL.F.A.R.L; SV2.v1;
SCH.EARTH; SV3.ACTIVE; SV3.ISL.F.A.R.L; SV3.v1;
SCH.EARTH; SV4.ACTIVE; SV4.ISL.F.A.R.L; SV4.v1;
GS1.ACTIVE.FIXED; GS1.NO_SHIELD; GS1.USER_DATA;
GS2.ACTIVE.FIXED; GS2.NO_SHIELD; GS2.USER_DATA;
EZ.NONE; CONTACT.START.5.24.2024.16:01:50;
CONTACT.START.5.24.2024.16:04:50;
MPS: GS1 > SV1 > SV2 > SV3 > GS2 (UEs attached to gNB.GS1.Cell
can communicate with gNB.GS2.Cell during contact time);

For example, in a third example corresponding to FIG. 3C, the following data values can be used to specify MPS parameters:

TABLE 4
SCH.EARTH; SV1.ACTIVE; SV1.ISL.F.A.R.L; SV1.v1;
SCH.EARTH; SV2.ACTIVE; SV2.ISL.F.A.R.L; SV2.v1;
SCH.EARTH; SV3.ACTIVE; SV3.ISL.F.A.R.L; SV3.v1;
SCH.EARTH; SV4.ACTIVE; SV4.ISL.F.A.R.L; SV4.DA; SV4.v2;
GS1.ACTIVE.FIXED; GS1.NO_SHIELD; GS1.USER_DATA;
GS2.ACTIVE.FIXED; GS2.NO_SHIELD; GS2.USER_DATA;
EZ.NONE; CONTACT.START.5.24.2024.16:01:50;
CONTACT.START.5.24.2024.16:04:50;
MPS: GS1 > SV1 > SV2 > SV3 > GS2 (UEs attached to gNB.GS1.Cell
can communicate with Direct Attach UE2 during contact time);

These and other MPS variations may be used to consider hardware or software versions in overall LEO scheduling. Accordingly, this can help solve issues related to determining which satellite has the capability to support direct attach, while solving issues related to incorporating exclusion and coordination zones and also incorporating AI modeling for routing and fault correction.

FIG. 6 depicts a flowchart 600 of an example method for coordinating mission planning and scheduling for network connectivity via a satellite constellation. While the operations in this flowchart 600 are presented and described sequentially, one of ordinary skill will appreciate that some or all of the operations may be executed in a different order, be combined or omitted, or be executed in parallel.

Operation 610 includes identifying an on-Earth location of a terrestrial terminal, where the terrestrial terminal will establish a data link to the satellite NTN. In an example, the satellite NTN includes multiple satellite vehicles that operate in a same orbit to provide coverage at varying times from respective satellite vehicles to the on-Earth location.

Operation 620 includes identifying respective times that satellite vehicles of the satellite NTN are within communication range or capability (e.g., within line-of-sight) to provide network connectivity for the data link to the terrestrial terminal at the on-Earth location.

Operation 630 includes determining payload capabilities of the satellite vehicles in the satellite NTN that will be within communication range or capability, such as by evaluating or identifying such payload capabilities. As discussed above, the payload capabilities enable the multiple satellite vehicles to perform varying types of connectivity and data processing within the satellite NTN. These payload capabilities can include hardware, firmware, and software configurations or versions that vary among some or all of the various satellite vehicles.

Operation 640 includes generating data link reservations for the multiple satellite vehicles to provide the network connectivity to the terrestrial terminal during the respective times. These data link reservations may be specifically arranged based on respective payload capabilities of respective satellite vehicles of the satellite NTN.

Operation 650 includes communicating the data link reservations to the respective satellite vehicles, to cause the respective satellite vehicles to reserve bandwidth or other capacity of a portion of an uplink and a downlink of the satellite NTN. In turn, these uplink and downlink resources can be used to provide the network connectivity to the terrestrial terminal at the on-Earth location during or in connection with the respective times.

In some examples, the data link reservations cause the satellite NTN to reserve resources for the data link using inter-satellite links among multiple satellites, such as within one or more constellations of satellite vehicles operating in one or more low-earth orbit orbital bands. These data link reservations may involve a use of inter-satellite links among the one or more constellations of satellite vehicles. In some examples, the data link reservations may also cause the satellite NTN to reserve resources for the data link using satellite-to-Earth links with one or more ground stations. In other examples, the network connectivity to the terrestrial terminal is provided with a direct attachment (direct connection) to a user equipment, such as in accordance with one or more frequency bands defined by a Fifth Generation (5G) Non-Terrestrial Network (NTN) network specification operating in a frequency division duplex (FDD) mode.

Further operations (not depicted) may include identifying communication exclusion or coordination restrictions applicable to the on-Earth location. The data link reservations may be generated to configure the uplink and the downlink of the satellite NTN to comply with the communication exclusion or coordination restrictions. These communication exclusion or coordination restrictions can be used to define one or more mitigations for transmissions from the satellite NTN to the on-Earth location. The one or more mitigations may be implemented with: spot beam control, frequency change, and/or beam steering.

Further operations (not depicted) may also include using a trained artificial intelligence model to determine characteristics of the data link reservations for the respective satellite vehicles, and/or using a trained artificial intelligence model to perform real-time adjustments of the uplink and the downlink, during use of the network connectivity to the terrestrial terminal for the respective times. Such AI operations may occur in connection with the data workflows described for FIG. 5.

In various examples, the operations of flowchart 600 may be performed by computing device located on-Earth or located in a satellite vehicle. Further, as discussed with reference to FIGS. 3A to 3D, the data link reservations may be communicated from the computing device to the respective satellite vehicles in connection with telemetry tracking and command (TTC) information provided to the satellite NTN.

### Edge Computing and Processing Via Satellite-Enabled Networks

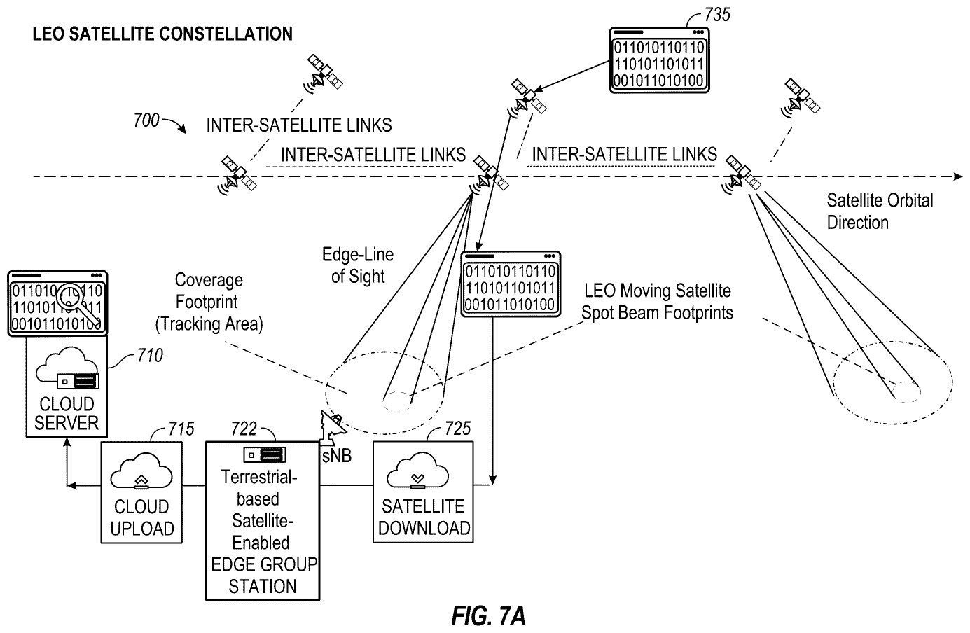

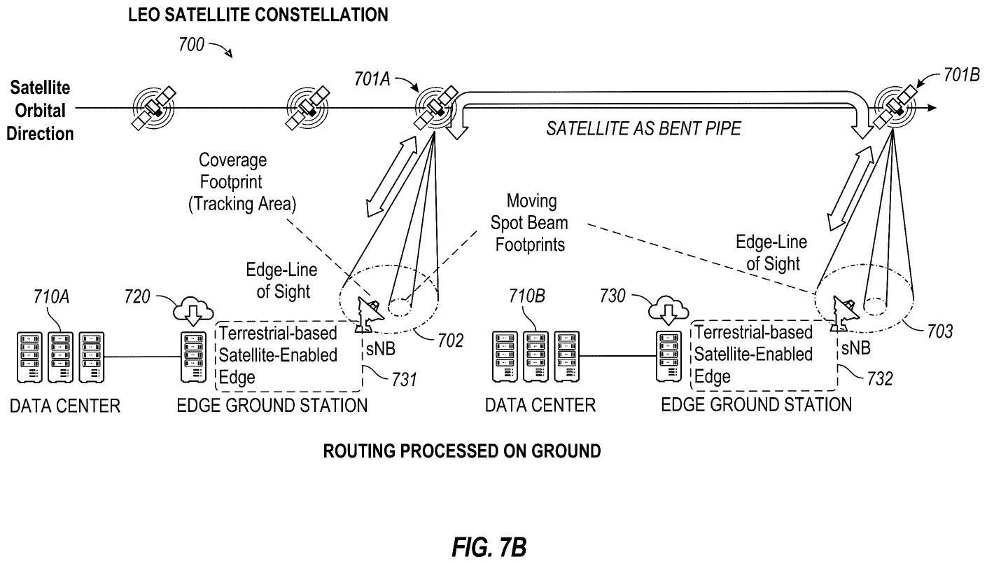

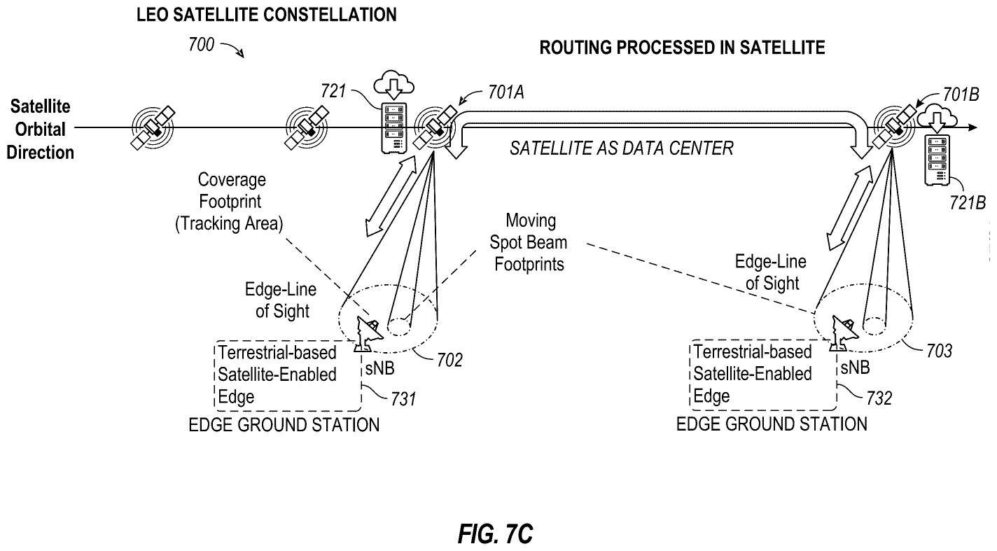

FIG. 7A illustrates an overview of terrestrial-based, satellite-enabled edge processing. As shown, a terrestrial-based, satellite enabled edge ground station (satellite nodeB, sNB) 722 obtains coverage from a satellite constellation 700, and downloads a data set 735. The satellite constellation 700 may coordinate operations to handoff the download using inter-satellite links (such as in a scenario where the data set 735 is streamed or cannot be fully downloaded before the satellite footprint moves).

The satellite download 725 is provided to the sNB 722 for processing, such as with a cloud upload 715 to a server 710 (e.g., a CDN located at or near the sNB 722). Accordingly, once downloaded to the sNB 722 (and uploaded to the server 710), the user devices located within the terrestrial coverage area (e.g., 5G coverage area) of the sNB 722 may now access the data from the server 710.

FIG. 7B illustrates a terrestrial-based, satellite-enabled edge processing arrangement, where routing is performed “on-ground”, and the satellite is used as a “bent pipe” between edge processing locations. Here, the term “bent pipe” refers to the use of a satellite or satellite constellation as a connection relay, to simply communicate data from one terrestrial location to another terrestrial location. As shown in this figure, a satellite constellation 700 has an orbital path, with a respective satellite moving from position 701A to 701B, providing separate coverage areas 702 and 703 for connectivity at respective times.

Here, when a satellite-enabled edge computing node (sNB) 731 is in the coverage area 702, it obtains connectivity via the satellite constellation 700 (at position 701A), to communicate with a wider area network. Additionally, this edge computing node sNB 731 may be located at an edge ground station 720 which is also in further communication with a data center 710A, for performing computing operations at a terrestrial location.

Likewise, when a satellite-enabled edge computing node (sNB) 732 is in the coverage area 703, it obtains connectivity via the satellite constellation 700 (at position 701B), to communicate with a wider area network. Again, computing operations (e.g., services, applications, etc.) are processed at a terrestrial location such as edge ground station 730 and data center 710B.

FIG. 7C illustrates another terrestrial-based, satellite-enabled edge processing arrangement. Similar to the arrangement depicted in FIG. 7B, this shows the satellite constellation 700 in a constellation along an orbital path, with a respective satellite moving from position 701A to 701B, providing separate coverage areas 702 and 703 at respective times. However, in this example, the satellite is used as a data center, to perform edge computing operations (e.g., serve data, compute data, relay data, etc.).

Specifically, at the satellite vehicle, edge computing hardware 721 is located to process computing or data requests received from the ground station sNBs 731, 732 in the coverage areas 702, 703. This may have the benefit of removing the communication latency involved with another location at the wide area network. However, due to processing and storage constraints, the amount of computation power may be limited at the satellite constellation 700 and thus some requests or operations may be moved to the ground station sNBs 731, 732.

As will be understood, edge computing and edge network connectivity may include various aspects of RAN and software defined networking processing. Specifically, in many of these scenarios, wireless termination may be moved between ground and satellite, depending on available processing resources. Further, in these scenarios, URLLC (ultra-reliable low latency connections) processing may be enabled, based on the configuration of inter-satellite communication links.

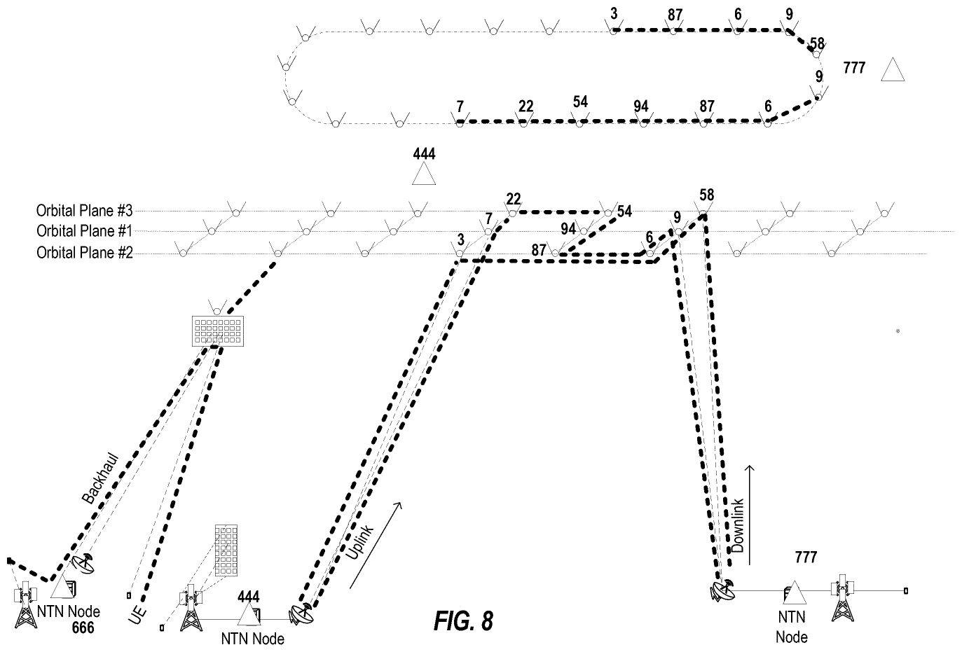

FIG. 8 provides a further illustration of how an NTN can enable uplink and downlink, involving various NTN Nodes. This example shows how an NTN Node contact initiating at GS444 with line of sight to SV3 using GS777 resources then back to GS444 using optical ISLs, while some SVs are still in line-of-sight. However, in some scenarios, it may be faster to use SV down to terrestrial GS/relays than back up. In other words, a ground relay path may be faster than optical ISL SVs.

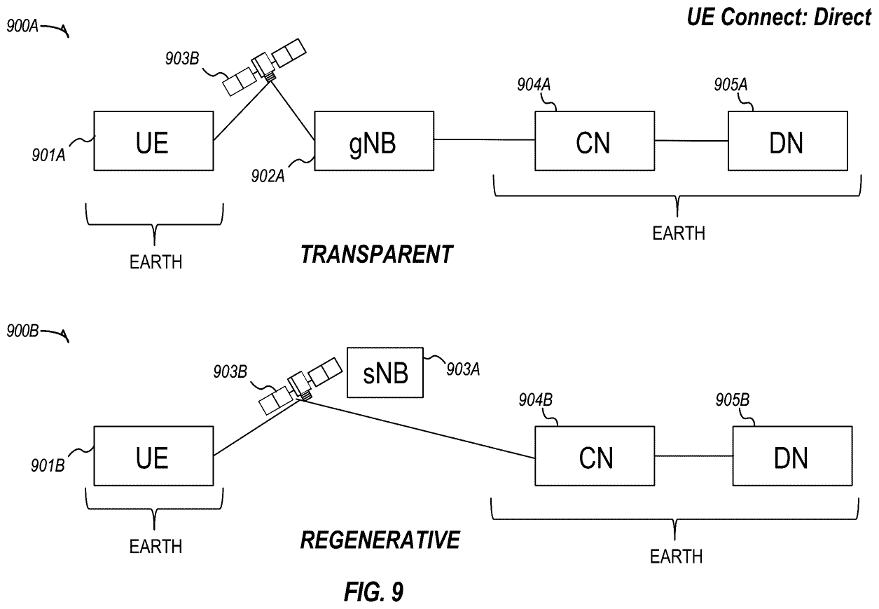

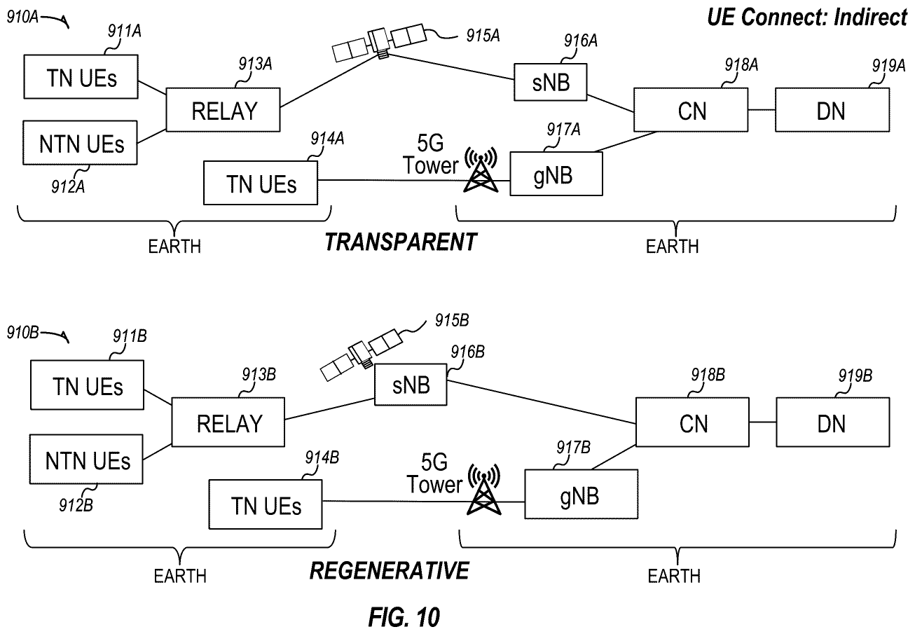

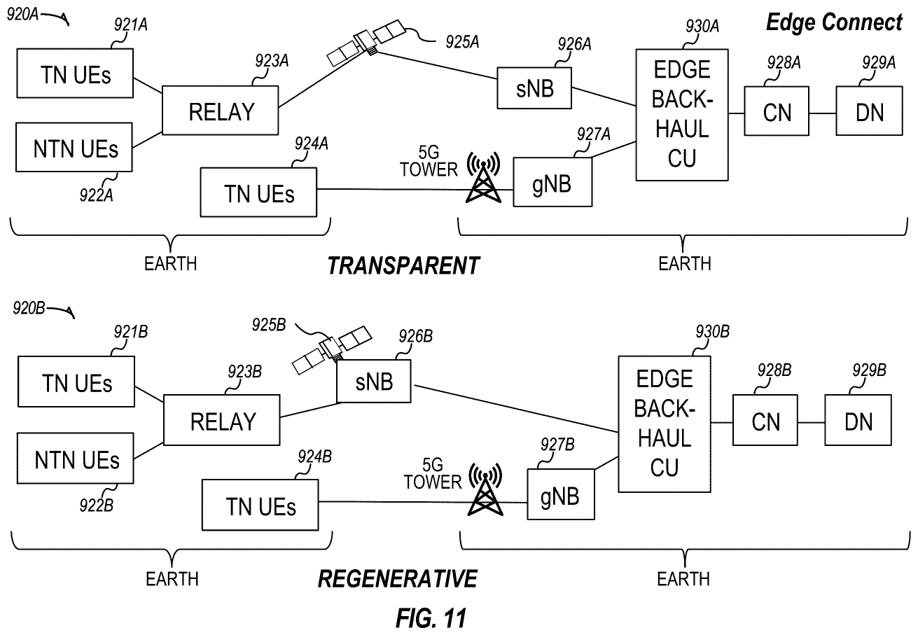

FIG. 9, FIG. 10, and FIG. 11 illustrate respective configurations of non-terrestrial and 5G network architectures, which may be used with the configurations and mitigation techniques discussed herein. These include:

Direct Connection (with a transparent or “bent pipe” satellite arrangement):

Scenario 900A in FIG. 9, e.g., Direct connect: UE 901A⇔[SATELLITE] 903B⇔gNB 902A⇔CN 904A⇔DN 905A;

Scenario 910A in FIG. 10, e.g., Multi-RAT, Multi Connectivity provided by transparent NTN-based NG-RAN and Cellular NG-RAN: UEs 911A or 912A⇔Relay 913A⇔[SATELLITE] 915A⇔gNB 916A⇔CN 918A⇔DN 919A (in this scenario 910A, TN UEs 914A can directly connect to a gNB 917A and the CN 918A, DN 919A).

Scenario 920A in FIG. 11, e.g., Multi-RAT, Multi Connectivity provided by transparent NTN-based NG-RAN and Cellular NG-RAN: UEs 921A or 922A⇔Relay 923A⇔[SATELLITE] 925A⇔sNB 926A ⇔Edge back-haul centralized unit (CU) 930A⇔CN 928A⇔DN 929A (in this scenario 910A, TN UEs 924A can directly connect to a gNB 927A and the CN 928A, DN 929A via the Edge back-haul CU 930A).

Direct Connection (with a regenerative satellite with gNB arrangement):

Scenario 900B in FIG. 9: UE 901B⇔sNB 903A [at SATELLITE 903B]⇔CN 904B⇔DN 905B;

Scenario 910B in FIG. 10, e.g., Multi-RAT, Multi Connectivity provided by transparent NTN-based NG-RAN and Cellular NG-RAN: UEs 911B or 912B⇔Relay 913B⇔sNB 916B [at SATELLITE 915B]⇔CN 918B⇔DN 919B (in this scenario 910B, TN UEs 914B can directly connect to a gNB 917B and the CN 918B, DN 919B).

Scenario 920B in FIG. 11, e.g., Multi-RAT, Multi Connectivity provided by transparent NTN-based NG-RAN and Cellular NG-RAN: UEs 921B or 922B⇔Relay 923B⇔sNB 926B [at SATELLITE 925B]⇔Edge back-haul CU 930B⇔CN 928B⇔DN 929B (in this scenario 920B, TN UEs 924B can directly connect to a gNB 927B and the CN 928B, DN 929B via the Edge back-haul CU 930B).

### Further Examples of Exclusion Zones and Exclusion Zone Implementations

FIG. 12 illustrates an implementation of SV-based exclusion zones for a non-terrestrial communication network, according to an example. This drawing provides additional detail on an example deployment of exclusion zones, over time, relative to a satellite 1201 at orbit positions 1201A, 1201B, 1201C. At position 1201A, the satellite 1201 provides coverage of its spot beam(s) in a first geographic area 1211; at position 1201B, the satellite 1201 provides coverage of its spot beam(s) in a second geographic area 1212; at position 1201C, the satellite 1201 provides coverage of its spot beam(s) in a third geographic area 1213.

FIG. 12 shows the implementation of a first exclusion zone 1221, which is a fixed geographic exclusion area. A fixed geographic exclusion area may be appropriate for preventing overlap with terrestrial networks which would conflict (e.g., cells established from a 4G/5G mobile network), or in fixed areas which are designated or instructed to be avoided (e.g., other countries, radio silence areas, sensitive monitoring equipment such as radio telescopes). FIG. 12 further shows the implementation of a second exclusion zone 1222, which is a mobile geographic exclusion area. A mobile geographic area may be appropriate for objects or areas that are in motion, moveable, or whose position is not necessarily fixed in a specific geographic area (e.g., airplanes, drones, other satellites), or for an area that has an irregular or changing shape. The implementation of either type of exclusion zone prevents the satellite from beaming on the area of conflict or restriction.

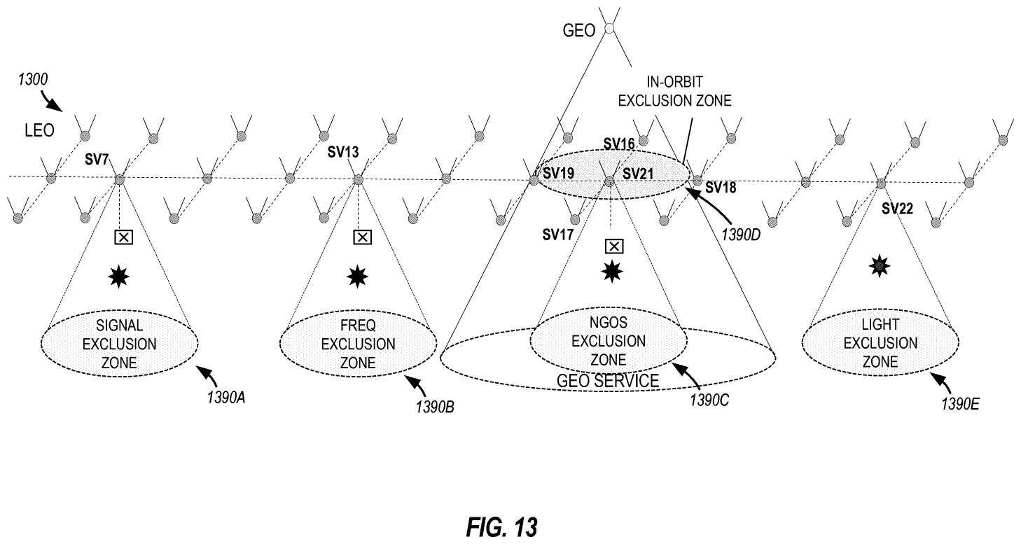

FIG. 13 illustrates further scenarios of network connectivity from an expanded view of a satellite constellation 1300, with the constellation comprising dozens of LEO satellites that provide connectivity to ground UEs (not shown). Within this scenario, a number of different exclusion zones are shown for deployment: a signal exclusion zone 1390A which blocks all signals from reaching a geographic area; a frequency exclusion zone 1390B which blocks certain frequency signals from reaching a geographic area; an non-geostationary orbit satellite (NGOS) exclusion zone 1390C which restricts signals from reaching a certain area which overlaps geostationary satellite service; an in-orbit exclusion zone 1390D which restricts inter-satellite communications which occur in an overlap of geostationary satellite service; and a light pollution exclusion zone 1390E which restricts reflection or causes some light reflection mitigation effect relative to an geographic area. Such exclusion zones 1390A-E may be separately or concurrently deployed with one another.

In the context of FIGS. 12 and 13, exclusion zones and mission planning and scheduling (as discussed above) can apply to multiple constellations serviced by separate providers. For instance, different constellations may have separate GMSS identifiers (i.e., satellite equivalent of PLMN). Exclusion zones may intercept all applicable constellations, since EZs are typically “fixed” and are independent of the constellation ownership and/or providers. LEO routing can be used to maintain orbit and ISL connectivity alignment and may be required to be communicated to the LEO vehicles on a frequent basis, such as each day.

Exclusion zones among ISLs may be implemented to be coordinated with planned network routing calculations and communications that already occur among ground and space nodes of the LEO network. For instance, the regular communication of routing information that is provided to LEO vehicles may also be used to provide a specification of multiple EZs at the same time (including, exclusion zones defined between SV-to-SV (to enable or disable ISLs) or between SV-Earth (to enable or disable geographic coverage)). The definition of exclusion zones with routing information increases efficiency of constellation, especially for form-flying constellations (e.g., similar to Iridium, Starlink, and the like).

In an example, exclusion zones can be calculated and provided with orbit and ISL connectivity alignment information. Thus, LEO SVs can be instructed to implement exclusion zones when receiving instructions to adjust orbital position. Such instructions may include turning various ISL connections on and off, adjusting right, left, fore, and aft antennas (regardless of implementation type), if a scenario is projected where an ISL is interfering with a higher-orbit satellite communication (or vice versa). Other considerations established with these exclusion zones may include routing that considers ground and space nodes, including EZs implemented at the same time (whether SV-to-SV or SV-earth exclusion zones), while increasing the efficiency of a constellation. These EZs may also consider that form-flying ISLs antennas often require (1) beam steering, (2) high directivity, and (3) longer ranges and larger apertures than free-flying swarm constellations.

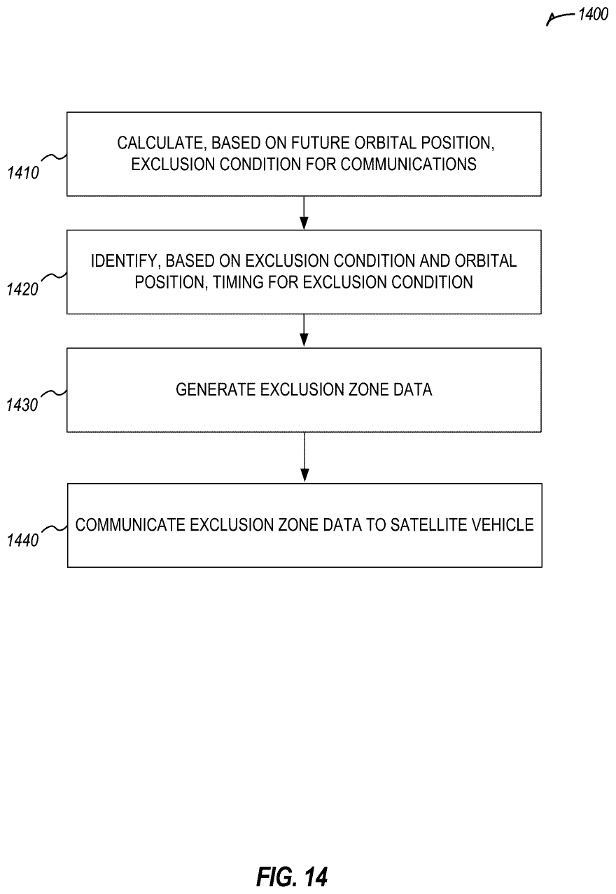

FIG. 14 illustrates a flowchart of an example method 1400 of defining and communicating exclusion zones.

The method begins, at operation 1410, to calculate, based on a future orbital position of a low-earth orbit satellite vehicle, an exclusion condition for communications from the satellite vehicle.

The method continues, at operation 1420, to identify, based on the exclusion condition and the future orbital position, a timing for implementing the exclusion condition for the communications from the satellite vehicle.

The method continues, at operation 1430, to generate exclusion zone data for use by the satellite vehicle. In an example, the exclusion zone data indicates the timing for implementing the exclusion condition for the communications from the satellite vehicle.

The method completes, at operation 1440, to cause communication of the exclusion zone data to the satellite vehicle. In an example, the operations of the method 1400 are performed by a ground-based data processing server at a regular interval, and this communication occurs from the ground-based data processing server to the satellite vehicle. In further examples, the operations of the method 1400 are performed at least in part using computing hardware of the satellite vehicle.

In an example, the exclusion condition of method 1400 is an exclusion of use of a communication frequency onto a terrestrial geographic area. For instance, the exclusion zone data may further identify the communication frequency, and implementation of the exclusion zone data at the satellite vehicle causes the satellite vehicle to discontinue use of the communication frequency while in communication range over the terrestrial geographic area.

In an example, the exclusion condition of method 1400 is an exclusion of use of a spot beam onto a terrestrial geographic area, and the exclusion zone data further identifies the spot beam of the satellite vehicle, as implementation of the exclusion zone data at the satellite vehicle causes the satellite vehicle to discontinue use of the spot beam while in communication range over the terrestrial geographic area. Related changes may include frequency changes or beam steering of the spot beams or relevant uplink/downlinks provided by the spot beams.

In an example, the exclusion condition of method 1400 is an exclusion of use of an inter-satellite link from the satellite vehicle, and the exclusion condition is based on the future orbital position overlapping with communications from another satellite vehicle. For instance, the inter-satellite link may be defined based on a fore, aft, right, or left direction from the satellite vehicle.

In an example, the exclusion condition of method 1400 is an exclusion of use of a cellular network coverage at a geographic area, and implementation of the exclusion zone data at the satellite vehicle causes the satellite vehicle to communicate a command to connected user equipment to discontinue use of a satellite network connection while the satellite vehicle is in communication range of the cellular network coverage at the geographic area.

In an example, the exclusion zone data of method 1400 is communicated to the satellite vehicle with a routing table, as the routing table operates to control the future orbital position of the satellite vehicle. In other examples, aspects of a routing protocol, routing protocol data, routing data, or configuration data (e.g., in a particular format) for routing and routing settings may be communicated. In a further example, the exclusion zone data includes attestation or authentication information for verification by the satellite vehicle. Additionally, in a further example, the exclusion zone data may be designated and used by a plurality of satellite vehicles in a constellation including the satellite vehicle.

The use of exclusion zones can be implemented in simple or complex terms, including simple methods to turn specific inter-satellite link antennas (and communication paths) off to reduce interference. This provides a method of imposing organic exclusion zones for constellation routing and reduces wear and tear on network and network processing.

In an example, a service provider can initiate an ISL interference mitigation exclusion zone, by communicating relevant parameters discussed in the examples below (e.g., EZ.id, EZ.name, EZ.ground, EZ.ground.radius, EZ.ground.lat, EZ.ground.long, EZ.ground.IP, EZ.ground.GPS, EZ.min.intensity). For example, such parameters may specify ID GEOsatelliten, and the characteristics of when an ISL exclusion zone should be in operation (e.g., when operating over a ground latitude and longitude at 111 degrees meridian west). A system implementing an ISV exclusion zone also may obtain future SV (fly-over) positions relative to a ground location. The response provided from a footprint command (e.g., Get SV Footprint, discussed below), may provide information to determine an expected response from fly-over telemetry (readily available via NORAD or from a constellation provider).

To prevent interference, a calculation of the exclusion zone may evaluate: (1) Does SV.n.fly-over overlap/intercept with EZ.n.area? (2) If there is overlap of the area, does SV.min.intensity>EZ.min.intensity? (3) If Yes, then prepare to turn-off (or lower intensity in accordance with a service provider agreement) the SV beams, links, or specific frequencies within beams or links by using an appropriate command (e.g., Set SV EZ command).

In an example, a Set SV EZ command is defined to include the following parameters to control inter-satellite communication links:

TABLE 5

| Parameter | Type | Comments |
|---|---|---|
| SV.EZ.fore | Int | On/off based on interference |
| SV.EZ.aft | Int | On/off based on interference |
| SV.EZ.right | Int | On/off based on interference |
| SV.EZ.left | Int | On/off based on interference |

In an example, with no interference, SV.EZ.fore, SV.EZ.aft, SV.EZ.right, and SV.EZ.left, are set to “on”. In an example, with calculated interference from other satellites, one or more of these values (e.g., SV.EZ.aft, SV.EZ.right, SV.EZ.left) are set to “off”, while zero or more of the values (e.g., “SV.EZ.fore”) are set to “on”. Thus, in scenarios where GEO and LEO deployments are overlapping via the LEO ISLs, the capability of turning on and off a link in a particular direction may immediately remedy any possible interference.

ISL EZs can also be defined to address potential interference concerns related to potential competitive LEO constellations or even for the same constellation in the different orbital planes. Thus, an exclusion zone may be defined to apply to particular frequency bands, or whatever frequency (e.g., to disable all ISLs of LEOs that fly under the GEO, or that have a potential of disruption based on other GEO, MEO, or LEOs).

In further examples, the consideration of interference or possible disruption, and the use of ISL EZs, may be based on a service provider policy. For example, a LEO provider which operates a premium service using ISLs, may disable or adapt aspects of the ISLs based on any possibility of disruption or interference (e.g., relying on ISL routing through other paths).

Accordingly, any of the examples of ISL EZs may be implemented and determined based on inter-constellation interference or disruption (e.g., within the same constellation), from other satellites or constellations (e.g., within different satellite altitudes) in the same or different orbital plane, or for policy considerations (e.g., to guarantee premium routing services do not encounter disruption). Other variation for the control, definition, and use of exclusion zones (and controls of frequency bands or types of communications within an exclusion zone) may be provided.

As will be understood, standard EZ Descriptions (and Language) can be shared across Terrestrial/Non-Terrestrial Service Providers for consistency and coordination among multiple-5G Terrestrial and geostationary/non-geostationary orbit (NGO) solutions. Implementations of EZs within separate Constellation Providers may vary but EZ Descriptions for ground-based keep-out areas may be sharable across Service Providers, including Cloud and Telecommunication Service Providers. In general, standard “fixed” EZs descriptions can be used to formulate and influence routing and switching payloads to help Service Providers coordinate as the number of NGO satellites and systems increase.

In an example, various commands for exclusion zones may include commands to: Define EZ (to define exclusion zones), Get SV (to obtain SV orbital fly-by information), and Set EZ (to implement an EZ within a constellation). Such commands may be extended for use with constellations, with the following definitions (with “EZn” referring to an identifier of an nth EZ):

TABLE 6
Define EZ (Define Exclusion Zone)

| Parameter | Type | Description |
|---|---|---|
| EZn.ID | INT | EZ Unique ID |
| EZn.NAME | STRING | EZ Name |
| EZn.RADIUS | FLOAT | EZ Radius for KEEP OUT |
| | | AREA |
| EZn.LAT.PT | FLOAT | EZ Latitude Ground/Sky |
| | | Center Point for KEEP OUT |
| | | AREA |
| EZn.LONG.PT | FLOAT | EZ Longitude Ground/Sky |
| | | Center Point for KEEP OUT |
| | | AREA |
| EZn.IP.PT | FLOAT | EZ IP Address Ground/Sky |
| | | Center Point for KEEP OUT |
| | | AREA |
| EZn.GPS.PT | FLOAT | EZ GPS Ground/Sky Center |
| | | Point for KEEP OUT AREA |
| EZn.MIN.INTENSITY.THRESHOLD | FLOAT | EZ Min Ground/Sky Center |
| | | Point Spot Beam/Freq |
| | | Intensity Threshold |
| EZn.MAX.INTENSITY.THRESHOLD | FLOAT | EZ Max Ground/Sky Center |
| | | Point Spot Beam/Freq |
| | | Intensity Threshold |
| EZn.ISL.TOGGLE | ON/OFF | EZ Intersatellite Link (ISL) |
| | | ON or OFF |
| EZn.LRM.TOGGLE | ON/OFF | EZ Light Reflection Mitigation |
| | | (LRM) ON or OFF |
| EZn.SPOT.TOGGLE | ON/OFF | EZ Spot Beam (SPOT) ON or |
| | | OFF |

TABLE 7
Get SV (Get SV Orbital “fly-by” information)

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.GND.lat | FLOAT | Ground location latitude for SV |
| | | fly-over |
| SVn.GND.long | FLOAT | Ground location longitude for SV |
| | | fly-over |
| SVn.GND.alt | FLOAT | Ground location altitude % for |
| | | intensity threshold calculations |
| SVn.GND.time | INT | Amount of time to obtain SV |
| | | flyover(s) |
| SVn.Period | Minutes | Location Minutes |
| SVn.Inclination | Degrees | Location Inclination |
| SVn.Apogee.Height | KM | Location Apogee |
| SVn.Perigee.Height | KM | Location Perigee |
| SVn.Eccentricity | FLOAT | Location Eccentricity |

TABLE 8
Set EZ (Implement EZ within Constellation)

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.SPOTn.TOGGLE | ON/OFF | SV Spot Beam n Downlink UTC |
| | | TIME START/STOP |
| SVn.SPOTn.FREQn.TOGGLE | ON/OFF | SV Spot Beam n Frequency n |
| | | Downlink UTC TIME START/STOP |
| SVn.ISL.FORE.TOGGLE | ON/OFF | SV Intersatellite Link UTC TIME |
| | | START/STOP |
| SVn.ISL.AFT.TOGGLE | ON/OFF | SV Intersatellite Link UTC TIME |
| | | START/STOP |
| SVn.ISL.RIGHT.TOGGLE | ON/OFF | SV Intersatellite Link UTC TIME |
| | | START/STOP |
| SVn.ISL.LEFT.TOGGLE | ON/OFF | SV Intersatellite Link UTC TIME |
| | | START/STOP |
| SVn.SHADE.TOGGLE | ON/OFF | SV Reflection Shade UTC TIME |
| | | START/STOP |
| SV.EZ.method | INT | ON/OFF or Intensity reduction |
| | | (e.g., based on service provider SLA) |

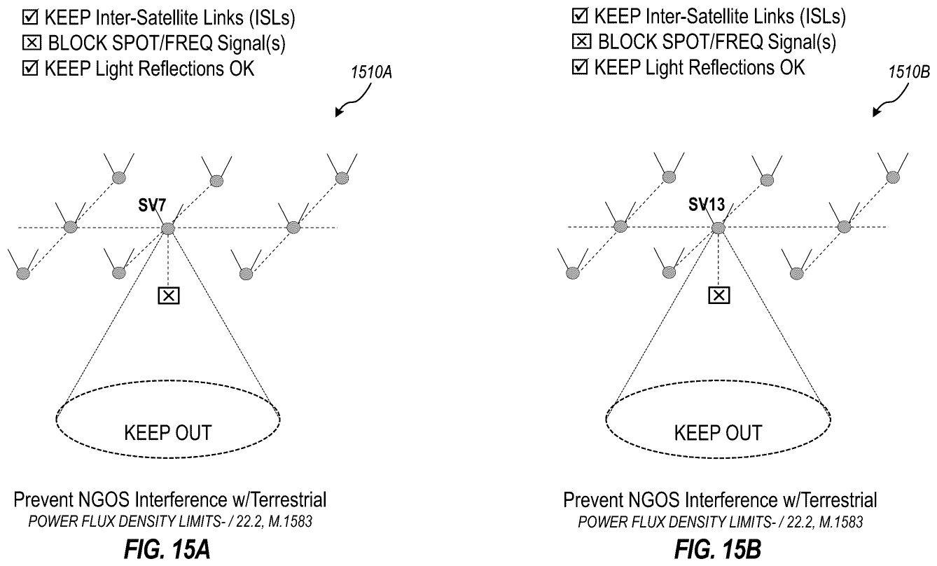

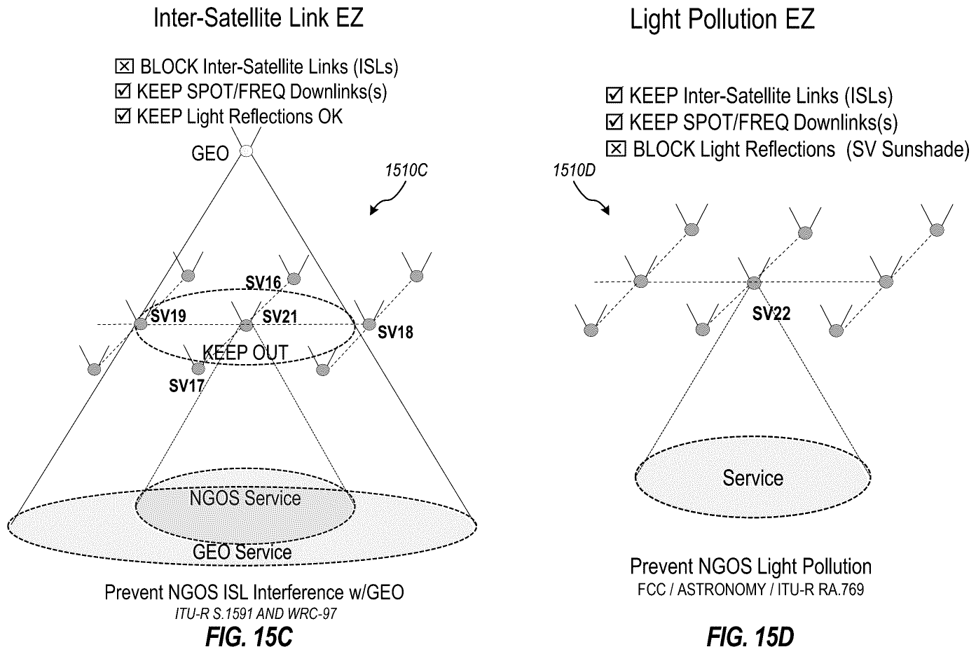

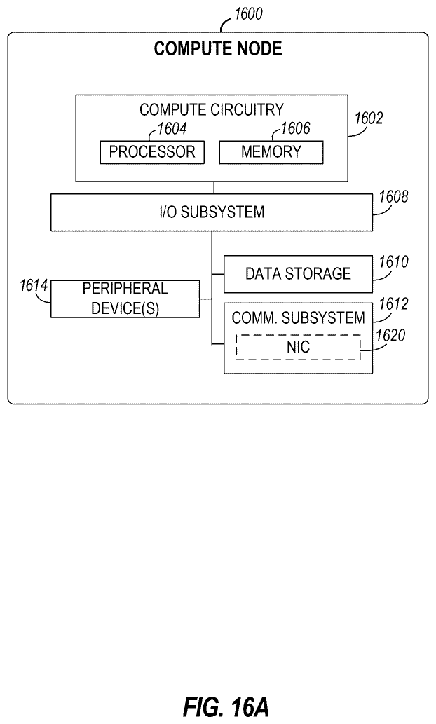

FIG. 15A illustrates further views of an example interference scenario 1510A over a geographic area, and the use of spot beam frequency exclusion zones to implement a keep-out area from SV7. Here, the intent of the EZ is to block specific signals from radiating on the ground, such as where different countries or geographical areas impose different intensity limits. For instance, to implement this exclusion zone based on frequency, values such as the following may be established via the following Define EZ (TABLE 9), Get SV (TABLE 10), and Set EZ (TABLE 11) commands:

TABLE 9
Define EZ (Input)

| Parameter | Value |
|---|---|
| EZn.ID | EZ22.12345 |
| EZn.NAME | EZ22.AZ_GND_STA- |
| | TION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 10
Get SV (input)

| Parameter | Value |
|---|---|
| SVn.ID.International | 2019-029BD |
| SVn.ID.NORAD | 44286 |
| SVn.ID.NAME | SV7 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 11
Set EZ (Output per SV)
(Disable different frequencies in respective spotbeams)

| Parameter | Value |
|---|---|
| SVn.ID.International | 2019-029BD |
| SVn.ID.NORAD | 44286 |
| SVn.ID.NAME | SV7 |
| SVn.SPOTn.TOGGLE | ON |
| SVn.SPOTn.FREQn.TOGGLE | SV7.SPOT1.FREQ2.DISABLE |
| | START 2021-03-03 21:43:56; |
| | STOP 2021-03-03 21:45:06; |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | ON >15% |

FIG. 15B illustrates further views of an example interference scenario 1510B over a geographic area, and the use of combined spot beam frequency exclusion zones to implement a keep-out area of all frequencies from a spot beam of SV13. For instance, to implement this exclusion zone for an entire spot beam, values such as the following may be established via the following Define EZ (TABLE 12), Get SV (TABLE 13), and Set EZ (TABLE 14) commands:

TABLE 12
Define EZ (Input)

| Parameter | Value |
|---|---|
| EZn.ID | EZ22.12345 |
| EZn.NAME | EZ22.AZ_GND_STA- |
| | TION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 13
Get SV (input)

| Parameter | Value |
|---|---|
| SVn.ID.International | 2019-029BD |
| SVn.ID.NORAD | 44286 |
| SVn.ID.NAME | SV13 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 14
Set EZ (Output per SV)
(Disable respective spotbeams)

| Parameter | Value |
|---|---|
| SVn.ID.International | 2019-029BD |
| SVn.ID.NORAD | 44286 |
| SVn.ID.NAME | SV13 |
| | SV13.SPOT2.DISABLE |
| | START 2021-05-04 22:43:56; |
| SVn.SPOTn.TOGGLE | STOP 2021-05-04 22:46:06; |
| SVn.SPOTn.FREQn.TOGGLE | OFF |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | OFF |

It will be understood that other variations may be implemented with EZs to block transmissions onto defined areas. For instance, such exclusion zones may provide permutations of a spot beam block, a frequency block within a beam, or an “ignore” setting when the intensity of the spot beam is below the intensity of allowance in the keep out zone.

FIG. 15C illustrates further views of an example interference scenario 1510C in inter-satellite communications of a non-terrestrial communication network. Depending on orbit positions, altitude, type of interference, and other characteristics, it is possible that some directions of communications (e.g., between satellite SV21 and SV19) will be determined to interfere or experience interference, whereas communications in a different direction (e.g., between satellite SV19 and other satellites) will not interfere or experience interference with higher-altitude satellite communications.

To implement an exclusion zone for control of inter-satellite links, values such as the following may be established for an exclusion zone involving SV21 of FIG. 15C via the following Define EZ (TABLE 15), Get SV (TABLE 16), and Set EZ (TABLE 17) commands:

TABLE 15
Define EZ (Input)

| Parameter | Value |
|---|---|
| EZn.ID | EZ22.12345 |
| EZn.NAME | EZ22.AZ_GEO_KO |
| EZn.RADIUS | 2000 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 16
Get SV (input)

| Parameter | Value |
|---|---|
| SVn.ID.International | 2019-029BD |
| SVn.ID.NORAD | 44286 |
| SVn.ID.NAME | SV21 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 17
Set EZ (Output per SV)
(Disable impacted ISLs)

| Parameter | Value |
|---|---|
| SVn.ID.International | 2019-029BD |
| SVn.ID.NORAD | 44286 |
| SVn.ID.NAME | SV21 |
| SVn.SPOTn.TOGGLE | |
| SVn.SPOTn.FREQn.TOGGLE | ON |
| SVn.ISL.FORE.TOGGLE | SV21.ISL.FORE.DISABLE |
| | START 2021-05-04 22:43:56; |
| | STOP 2021-05-04 22:46:06; |
| SVn.ISL.AFT.TOGGLE | SV21.ISL.AFT.DISABLE |
| | START 2021-05-04 22:43:56; |
| | STOP 2021-05-04 22:46:06; |
| SVn.ISL.RIGHT.TOGGLE | SV21.ISL.RIGHT.DISABLE |
| | START 2021-05-04 22:43:56; |
| | STOP 2021-05-04 22:46:06; |
| SVn.ISL.LEFT.TOGGLE | SV21.ISL.LEFT.DISABLE |
| | START 2021-05-04 22:43:56; |
| | STOP 2021-05-04 22:46:06; |
| SVn.SHADE.TOGGLE | ON |
| SV.EZ.method | OFF |

As shown in FIG. 15C, the EZ for ISLs is defined relative to the GEO coverage area. To implement an exclusion zone for control of inter-satellite links for SV20, SV18, SV17, SV16, to meet the scenario shown in FIG. 15C, the Get SV (TABLE 16) SVn.ID.NAME and Set EZ (TABLE 17) SVn.ID.NAME values would substitute “SV21” with the respective “SV20”, “SV18”, “SV17”, “SV16” values, and the Set EZ (TABLE 17) SV.ISL.FORE, .AFT, .LEFT, . . . .RIGHT toggle values would substitute with values relevant to the respective SVs.

FIG. 15D illustrates further views of an example light pollution scenario 1510D based on reflections from individual SVs of a non-terrestrial communication network. To implement an exclusion zone for control of SV mechanisms to mitigate light reflections, values such as the following may be established for an exclusion zone involving SV22 of FIG. 15D via the following Define EZ (TABLE 18), Get SV (TABLE 19), and Set EZ (TABLE 20) commands:

TABLE 18
Define EZ (Input)

| Parameter | Value |
|---|---|
| EZn.ID | EZ22.12345 |
| EZn.NAME | EZ22.AZ_ASTRO |
| EZn.RADIUS | 50 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 19
Get SV (input)

| Parameter | Value |
|---|---|
| SVn.ID.International | 2019-029BD |
| SVn.ID.NORAD | 44333 |
| SVn.ID.NAME | SV22 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 20
Set EZ (Output per SV)
(Shade SV)

| Parameter | Value |
|---|---|
| SVn.ID.International | 2019-029BD |
| SVn.ID.NORAD | 44333 |
| SVn.ID.NAME | SV22 |
| SVn.SPOTn.TOGGLE | |
| SVn.SPOTn.FREQn.TOGGLE | ON |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | SV22.SHADE ENABLED |
| | START 2021-05-04 22:43:56; |
| | STOP 2021-05-04 22:46:06; |
| SV.EZ.method | OFF |

Other permutations of the previously described EZs may include establishing borders or zones between different LEO constellations, such as to prevent LEO constellations from different service providers from talking with one another. Likewise, other permutations may involve cooperation between constellations to enable or restrict aspects of “roaming” or accessing services offered from other service providers, network companies, or countries.

Similar to above, specific commands and values to define a SCS EZ, CZ, or a corresponding “inclusion zone” (IZ) may include the following:

TABLE 21
Define SCS Zone

| Parameter | Type | Description |
|---|---|---|
| SCS.ID | INT | EZ/IZ Unique ID |
| SCS.NAME | STRING | EZ/IZ Name |
| SCS.RADIUS | FLOAT | EZ/IZ Radius |
| SCSn.LAT.PT | FLOAT | EZ/IZ Latitude Ground/Buffer |
| | | Center Point |
| SCSn.LONG.PT | FLOAT | EZ/IZ Longitude |
| | | Ground/Buffer Center Point |
| SCSn.IP.PT | FLOAT | EZ/IZ IP Address |
| | | Ground/Buffer Center Point |
| SCSn.GPS.PT | FLOAT | EZ/IZ GPS Ground/Buffer |
| | | Center Point |
| SCSn.MIN.FREQBAND.THRESHOLD | FLOAT | EZ/IZ disallowed Freq Band |
| | | MIN Range |
| SCSn.MAX.FREQBAND.THRESHOLD | FLOAT | EZ/IZ disallowed Freq Band |
| | | MAX Range |
| SCSn.MIN.INTENSITY.THRESHOLD | FLOAT | EZ/IZ Min Ground/Buffer |
| | | Center Point Freq Band/Freq |
| | | Intensity Threshold |
| SCSn.MAX.INTENSITY.THRESHOLD | FLOAT | EZ/IZ Max Ground/Buffer |
| | | Center Point Freq Band/Freq |
| | | Intensity Threshold |
| SCSn.MIN.Weather.THRESHOLD | FLOAT | EZ/IZ Min physical env |
| | | weather Threshold |
| SCSn.MAX.Weather.THRESHOLD | FLOAT | EZ/IZ Max physical env |
| | | weather Threshold (e.g., |
| | | hurricane category 2 wind |
| | | sheer >10 mph) |
| SCSn.OTHER.THRESHOLD | FLOAT | EZ/IZ OTHER OPEN variable |
| SCSn.RADIO.TOGGLE | ON/OFF | EZ/IZ Radio ON or OFF |
| SCS_ZONE.BER | | Bit Error Rate |
| SCS_ZONE.CNR | | Carrier to Noise Ratio |
| SCS_ZONE.PFD | | Power Flux Density |
| SCS_ZONE.RIP | | Received isotropic power |
| SCS_ZONE.EIRP | | Effective isotropic radiated |
| | | power |
| SCS_ZONE.AG | | Antenna Gain |
| SCS_ZONE_Proximity | | Debris and or other Proximity |
| Constraint | | Alerts or Keep Outs |

### Implementation in Edge Computing Scenarios

It will be understood that the present communication and networking arrangements may be integrated with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by: moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

Compute, memory, and storage are scarce resources, and generally decrease depending on the edge location (e.g., fewer processing resources being available at consumer end point devices than at a base station or at a central office). However, the closer that the edge location is to the endpoint (e.g., UEs), the more that space and power is constrained. Thus, edge computing, as a general design principle, attempts to minimize the amount of resources needed for network services, through the distribution of more resources which are located closer both geographically and in network access time. In the scenario of non-terrestrial network, distance and latency may be far to and from the satellite, but data processing may be better accomplished at edge computing hardware in the satellite vehicle rather than requiring additional data connections and network backhaul to and from the cloud.

In an example, an edge cloud architecture extends beyond typical deployment limitations to address restrictions that some network operators or service providers may have in their own infrastructures. These include, variation of configurations based on the edge location (because edges at a base station level, for instance, may have more constrained performance); configurations based on the type of compute, memory, storage, fabric, acceleration, or like resources available to edge locations, tiers of locations, or groups of locations; the service, security, and management and orchestration capabilities; and related objectives to achieve usability and performance of end services.

Consistent with the examples provided herein, a client compute node may be embodied as any type of endpoint component, circuitry, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge computing network or cloud.

The network components of the edge computing network or cloud may be servers, multi-tenant servers, appliance computing devices, and/or any other type of computing devices. For example, a node of the edge computing network or cloud may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc.

Consistent with the examples provided herein, each compute node may be embodied as any type of end point component, device, appliance, or “thing” capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge computing network or cloud.

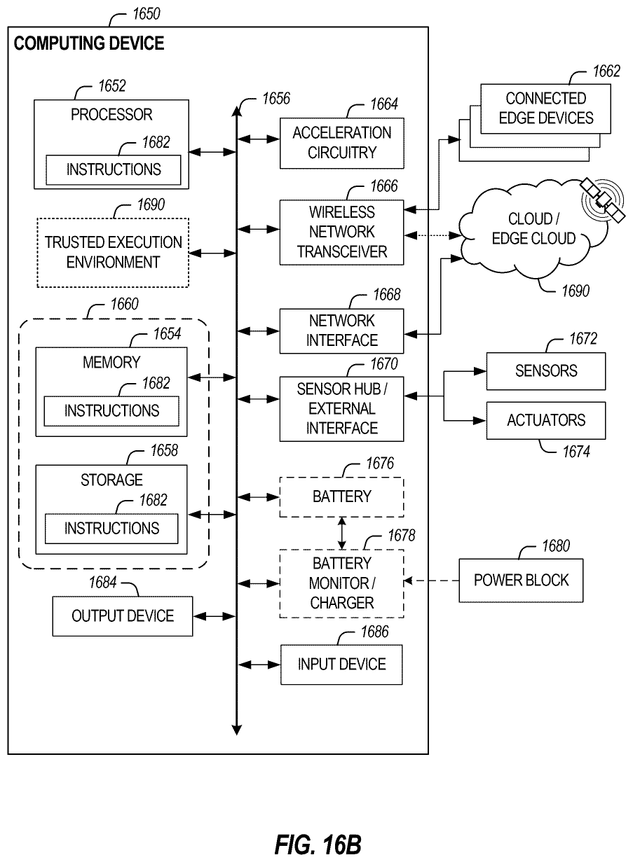

In further examples, any of the compute nodes or devices discussed with reference to the present computing systems and environment may be fulfilled based on the components depicted in FIGS. 16A and 16B. Each compute node may be embodied as a type of device, appliance, computer, or other “thing” capable of communicating with other edge, networking, or endpoint components.

In the simplified example depicted in FIG. 16A, an edge compute node 1600 includes a compute engine (also referred to herein as “compute circuitry”) 1602, an input/output (I/O) subsystem 1608, data storage device 1610, communication circuitry 1612, and, optionally, one or more peripheral devices 1614. In other examples, each compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1600 may be embodied as any type of engine, device, or collection of devices capable of performing various compute functions. In some examples, the compute node 1600 may be embodied as a single device such as an integrated circuit, an embedded system, a field-programmable gate array (FPGA), a system-on-a-chip (SOC), or other integrated system or device. In the illustrative example, the compute node 1600 includes or is embodied as a processor 1604 and a memory 1606. The processor 1604 may be embodied as any type of processor capable of performing the functions described herein (e.g., executing an application). For example, the processor 1604 may be embodied as a multi-core processor(s), a microcontroller, or other processor or processing/controlling circuit. In some examples, the processor 1604 may be embodied as, include, or be coupled to an FPGA, an application specific integrated circuit (ASIC), reconfigurable hardware or hardware circuitry, or other specialized hardware to facilitate performance of the functions described herein.

The main memory 1606 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory, other storage class memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1606 may be integrated into the processor 1604. The main memory 1606 may store various software and data used during operation such as one or more applications, data operated on by the application(s), libraries, and drivers.

The compute circuitry 1602 is communicatively coupled to other components of the compute node 1600 via the I/O subsystem 1608, which may be embodied as circuitry and/or components to facilitate input/output operations with the compute circuitry 1602 (e.g., with the processor 1604 and/or the main memory 1606) and other components of the compute circuitry 1602. For example, the I/O subsystem 1608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1608 may form a portion of a system-on-a-chip (SoC) and be incorporated, along with one or more of the processor 1604, the main memory 1606, and other components of the compute circuitry 1602, into the compute circuitry 1602.

The data storage devices 1610 may be embodied as any type of devices configured for short-term or long-term storage of data such as, for example, memory devices and circuits, memory cards, hard disk drives, solid-state drives, or other data storage devices. Each data storage device 1610 may include a system partition that stores data and firmware code for the data storage device 1610. Each data storage device 1610 may also include one or more operating system partitions that store data files and executables for operating systems depending on, for example, the type of compute node 1600.

The communication circuitry 1612 may be embodied as any communication circuit, device, or collection thereof, capable of enabling communications over a network between the compute circuitry 1602 and another compute device. The communication circuitry 1612 may be configured to use any one or more communication technology (e.g., wired, or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The illustrative communication circuitry 1612 includes a network interface controller (NIC) 1620, which may also be referred to as a host fabric interface (HFI). The NIC 1620 may be embodied as one or more add-in-boards, daughter cards, network interface cards, controller chips, chipsets, or other devices that may be used by the compute node 1600 to connect with another compute device. In some examples, the NIC 1620 may be embodied as part of a system-on-a-chip (SoC) that includes one or more processors, or included on a multichip package that also contains one or more processors. In some examples, the NIC 1620 may include a local processor (not shown) and/or a local memory (not shown) that are both local to the NIC 1620. In such examples, the local processor of the NIC 1620 may be capable of performing one or more of the functions of the compute circuitry 1602 described herein. Additionally, or alternatively, in such examples, the local memory of the NIC 1620 may be integrated into one or more components of the client compute node at the board level, socket level, chip level, and/or other levels.

Additionally, in some examples, each compute node 1600 may include one or more peripheral devices 1614. Such peripheral devices 1614 may include any type of peripheral device found in a compute device or server such as audio input devices, a display, other input/output devices, interface devices, and/or other peripheral devices, depending on the particular type of the compute node 1600. In further examples, the compute node 1600 may be embodied by a respective edge compute node in an edge computing system or like forms of appliances, computers, subsystems, circuitry, or other components.

In a more detailed example, FIG. 16B illustrates a block diagram of an example of components that may be present in an edge computing node 1650 for implementing the techniques (e.g., operations, processes, methods, and methodologies) described herein. The edge computing node 1650 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1650, or as components otherwise incorporated within a chassis of a larger system. Further, to support the security examples provided herein, a hardware ROT (e.g., provided according to a DICE architecture) may be implemented in each IP block of the edge computing node 1650 such that any IP Block could boot into a mode where a RoT identity could be generated that may attest its identity and its current booted firmware to another IP Block or to an external entity.

The edge computing node 1650 may include processing circuitry in the form of a processor 1652, which may be a microprocessor, a multi-core processor, a multithreaded processor, an ultra-low voltage processor, an embedded processor, or other known processing elements. The processor 1652 may be a part of a system on a chip (SoC) in which the processor 1652 and other components are formed into a single integrated circuit, or a single package, such as the Edison™ or Galileo™ SoC boards from Intel Corporation, Santa Clara, California. As an example, the processor 1652 may include an Intel® Architecture Core™ based processor, such as a Quark™, an Atom™, a Xeon™ an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd., or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1652 may communicate with a system memory 1654 over an interconnect 1656 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1658 may also couple to the processor 1652 via the interconnect 1656. In an example, the storage 1658 may be implemented via a solid-state disk drive (SSDD). Other devices that may be used for the storage 1658 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1658 may be on-die memory or registers associated with the processor 1652. However, in some examples, the storage 1658 may be implemented using a micro hard disk drive (HDD). Further, any number of new technologies may be used for the storage 1658 in addition to, or instead of, the technologies described, such resistance change memories, phase change memories, holographic memories, or chemical memories, among others.

The components may communicate over the interconnect 1656. The interconnect 1656 may include any number of technologies, including industry standard architecture (ISA), extended ISA (EISA), peripheral component interconnect (PCI), peripheral component interconnect extended (PCIx), PCI express (PCIe), NVLink, or any number of other technologies. The interconnect 1656 may be a proprietary bus, for example, used in an SoC based system. Other bus systems may be included, such as an I2C interface, an SPI interface, point to point interfaces, and a power bus, among others.

The interconnect 1656 may couple the processor 1652 to a transceiver 1666, for communications with the connected edge devices 1662. The transceiver 1666 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1662. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1666 (or multiple transceivers) may communicate using multiple standards or radios for communications at a different range. For example, the edge computing node 1650 may communicate with close devices, e.g., within about 10 meters, using a local transceiver based on BLE, or another low power radio, to save power. More distant connected edge devices 1662, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1666 (e.g., a radio transceiver) may be included to communicate with devices or services in the edge cloud 1690 via local or wide area network protocols. The wireless network transceiver 1666 may be an LPWA transceiver that follows the IEEE 802.15.4, or IEEE 802.15.4g standards, among others. The edge computing node 1650 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1666, as described herein. For example, the transceiver 1666 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1666 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1668 may be included to provide a wired communication to nodes of the edge cloud 1690 or to other devices, such as the connected edge devices 1662 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1668 may be included to enable connecting to a second network, for example, a first NIC 1668 providing communications to the cloud over Ethernet, and a second NIC 1668 providing communications to other devices over another type of network.

Given the variety of types of applicable communications from the device to another component or network, applicable communications circuitry used by the device may include or be embodied by any one or more of components such as circuitry 1664, transceiver 1666, NIC 1668, or interface 1670. Accordingly, in various examples, applicable means for communicating (e.g., receiving, transmitting, etc.) may be embodied by such communications circuitry.

The edge computing node 1650 may include or be coupled to acceleration circuitry 1664, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning training, inferencing, classification, and detection operations, and related processes such as system state collection and analysis), visual data processing, network data processing, object detection, rule analysis, or the like. Accordingly, in various examples, applicable means for acceleration may be embodied by such acceleration circuitry.

The interconnect 1656 may couple the processor 1652 to a sensor hub or external interface 1670 that is used to connect additional devices or subsystems. The devices may include sensors 1672, such as accelerometers, level sensors, flow sensors, optical light sensors, camera sensors, temperature sensors, a global positioning system (GPS) sensors, pressure sensors, barometric pressure sensors, and the like. The hub or interface 1670 further may be used to connect the edge computing node 1650 to actuators 1674, such as power switches, valve actuators, an audible sound generator, a visual warning device, and the like.

In some optional examples, various input/output (I/O) devices may be present within or connected to, the edge computing node 1650. For example, a display or other output device 1684 may be included to show information, such as sensor readings or actuator position. An input device 1686, such as a touch screen or keypad may be included to accept input. An output device 1684 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1650.

A battery 1676 may power the edge computing node 1650, although, in examples in which the edge computing node 1650 is mounted in a fixed location, it may have a power supply coupled to an electrical grid. The battery 1676 may be a lithium ion battery, or a metal-air battery, such as a zinc-air battery, an aluminum-air battery, a lithium-air battery, and the like.

A battery monitor/charger 1678 may be included in the edge computing node 1650 to track the state of charge (SoCh) of the battery 1676. The battery monitor/charger 1678 may be used to monitor other parameters of the battery 1676 to provide failure predictions, such as the state of health (SoH) and the state of function (SoF) of the battery 1676. The battery monitor/charger 1678 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1678 may communicate the information on the battery 1676 to the processor 1652 over the interconnect 1656. The battery monitor/charger 1678 may also include an analog-to-digital (ADC) converter that enables the processor 1652 to directly monitor the voltage of the battery 1676 or the current flow from the battery 1676. The battery parameters may be used to determine actions that the edge computing node 1650 may perform, such as transmission frequency, mesh network operation, sensing frequency, and the like.

A power block 1680, or other power supply coupled to a grid, may be coupled with the battery monitor/charger 1678 to charge the battery 1676. In some examples, the power block 1680 may be replaced with a wireless power receiver to obtain the power wirelessly, for example, through a loop antenna in the edge computing node 1650. A wireless battery charging circuit, such as an LTC4020 chip from Linear Technologies of Milpitas, California, among others, may be included in the battery monitor/charger 1678. The specific charging circuits may be selected based on the size of the battery 1676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1658 may include instructions 1682 in the form of software, firmware, or hardware commands to implement the techniques described herein. Although such instructions 1682 are shown as code blocks included in the memory 1654 and the storage 1658, it may be understood that any of the code blocks may be replaced with hardwired circuits, for example, built into an application specific integrated circuit (ASIC).

In an example, the instructions 1682 provided via the memory 1654, the storage 1658, or the processor 1652 may be embodied as a non-transitory, machine-readable medium 1660 including code to direct the processor 1652 to perform electronic operations in the edge computing node 1650. The processor 1652 may access the non-transitory, machine-readable medium 1660 over the interconnect 1656. For instance, the non-transitory, machine-readable medium 1660 may be embodied by devices described for the storage 1658 or may include specific storage units such as optical disks, flash drives, or any number of other hardware devices. The non-transitory, machine-readable medium 1660 may include instructions to direct the processor 1652 to perform a specific sequence or flow of actions, for example, as described with respect to the flowchart(s) and block diagram(s) of operations and functionality depicted above. As used herein, the terms “machine-readable medium” and “computer-readable medium” are interchangeable.

In further examples, a machine-readable medium also includes any tangible medium that is capable of storing, encoding, or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically, or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 16A and 16B are intended to depict a high-level view of components of a device, subsystem, or arrangement of an edge computing node. However, it will be understood that some of the components shown may be omitted, additional components may be present, and a different arrangement of the components shown may occur in other implementations.

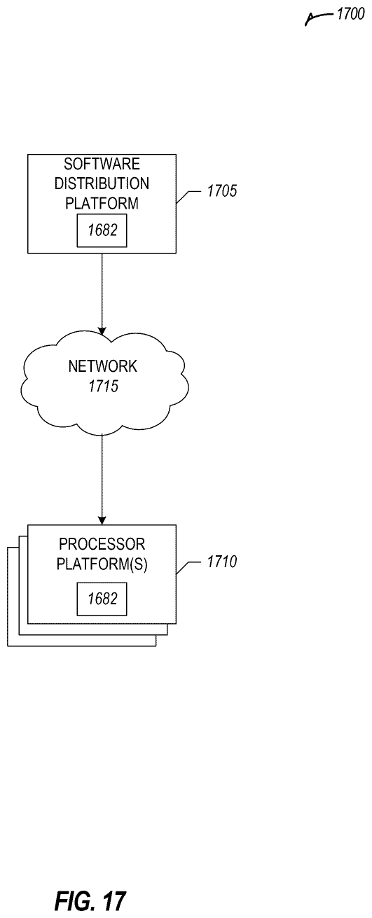

FIG. 17 illustrates an example software distribution platform 1705 to distribute software, such as the example computer readable instructions 1682 of FIG. 16B, to one or more devices, such as example processor platform(s) 1710 and/or other example connected edge devices or systems discussed herein. The example software distribution platform 1705 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1705). Example connected edge devices may operate in commercial and/or home automation environments. In some examples, a third party is a developer, a seller, and/or a licensor of software such as the example computer readable instructions 1682 of FIG. 16B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 17, the software distribution platform 1705 includes one or more servers and one or more storage devices that store the computer readable instructions 1682. The one or more servers of the example software distribution platform 1705 are in communication with a network 1715, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1682 from the software distribution platform 1705. For example, the software, which may correspond to example computer readable instructions, may be downloaded to the example processor platform(s), which is/are to execute the computer readable instructions 1682. In some examples, one or more servers of the software distribution platform 1705 are communicatively connected to one or more security domains and/or security devices through which requests and transmissions of the example computer readable instructions 1682 must pass. In some examples, one or more servers of the software distribution platform 1705 periodically offer, transmit, and/or force updates to the software (e.g., the example computer readable instructions 1682 of FIG. 16B) to ensure improvements, patches, updates, etc. are distributed and applied to the software at the end user devices.

In the illustrated example of FIG. 17, the computer readable instructions 1682 are stored on storage devices of the software distribution platform 1705 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1682 stored in the software distribution platform 1705 are in a first format when transmitted to the example processor platform(s) 1710. In some examples, the first format is an executable binary in which particular types of the processor platform(s) 1710 can execute. However, in some examples, the first format is uncompiled code that requires one or more preparation tasks to transform the first format to a second format to enable execution on the example processor platform(s) 1710. For instance, the receiving processor platform(s) 1700 may need to compile the computer readable instructions 1682 in the first format to generate executable code in a second format that is capable of being executed on the processor platform(s) 1710. In still other examples, the first format is interpreted code that, upon reaching the processor platform(s) 1710, is interpreted by an interpreter to facilitate execution of instructions.

In the examples above, many references were provided to low-earth orbit (LEO) satellites and constellations. However, it will be understood that the examples above are also relevant to many forms of middle-earth orbit satellites and constellations, geosynchronous orbit satellites and constellations, and other high altitude communication platforms such as balloons. Thus, it will be understood that the techniques discussed for LEO network settings are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually, and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

### Example Implementation Systems and Methods

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method (e.g., for performing mission planning and scheduling for terminal connectivity with a satellite non-terrestrial network (NTN)), the method comprising: identifying an on-Earth location of a terrestrial terminal, the terrestrial terminal to establish a data link via the satellite NTN; identifying respective times that satellite vehicles in the satellite NTN are within line-of-sight to provide network connectivity for the data link to the terrestrial terminal at the on-Earth location; evaluating (e.g., determining or identifying) payload capabilities of the satellite vehicles to perform varying types of connectivity and data processing within the satellite NTN; generating data link reservations for the satellite vehicles to provide the network connectivity for the data link with the terrestrial terminal during the respective times, based on respective payload capabilities of respective satellite vehicles of the satellite NTN; and communicating the data link reservations to the satellite vehicles, the data link reservations to cause the respective satellite vehicles to reserve a portion of an uplink and a downlink of the satellite NTN to provide the network connectivity to the terrestrial terminal at the on-Earth location during the respective times.

In Example 2, the subject matter of Example 1 optionally includes wherein the respective payload capabilities of the satellite vehicles include hardware, firmware, and software configurations that vary among some of the satellite vehicles, and wherein the satellite vehicles are in a same orbit to provide coverage at varying times from the respective satellite vehicles to the on-Earth location.

In Example 3, the subject matter of any one or more of Examples 1-2 optionally include wherein the data link reservations cause the satellite NTN to reserve resources for the data link using inter-satellite links among multiple satellites, the multiple satellites operating within one or more constellations of satellite vehicles in one or more low-earth orbit orbital bands.

In Example 4, the subject matter of any one or more of Examples 1-3 optionally includes wherein the data link reservations cause the satellite NTN to reserve resources for the data link using satellite-to-earth links with one or more ground stations.

In Example 5, the subject matter of any one or more of Examples 1-4 optionally include wherein the network connectivity to the terrestrial terminal is provided with a direct attachment to a user equipment, in accordance with one or more frequency bands defined by or incorporated into a Fifth Generation (5G) Non-Terrestrial Network (NTN) network specification (e.g., 3GPP TS 38.821, Release 16; TS 38.863, Release 17; 3GPP TS 23.501, Release 15 and thereafter; TS 23.700-01, Release 19, etc.) operating in a frequency division duplex (FDD) mode.

In Example 6, the subject matter of any one or more of Examples 1-5 optionally include identifying communication exclusion or coordination restrictions applicable to the on-Earth location, and wherein the data link reservations configure the uplink and the downlink of the satellite NTN to comply with the communication exclusion or coordination restrictions.

In Example 7, the subject matter of Example 6 optionally includes wherein the communication exclusion or coordination restrictions define one or more mitigations for transmissions from the satellite NTN to the on-Earth location, the one or more mitigations provided from: spot beam control, frequency change, or beam steering.

In Example 8, the subject matter of any one or more of Examples 1-7 optionally include using a trained artificial intelligence model to determine characteristics of the data link reservations for the respective satellite vehicles.

In Example 9, the subject matter of any one or more of Examples 1-8 optionally include using a trained artificial intelligence model to perform real-time adjustments of the uplink and the downlink, during use of the network connectivity to the terrestrial terminal for the respective times.

In Example 10, the subject matter of any one or more of Examples 1-9 optionally include wherein the method is performed by a computing device located on-Earth or located in a satellite vehicle, and wherein the data link reservations are communicated from the computing device to the respective satellite vehicles in connection with telemetry tracking and command (TTC) information provided to the satellite NTN.

Example 11 is a computing device, comprising: processing circuitry; and at least one machine-readable medium including instructions embodied thereon, wherein the instructions, when executed by the processing circuitry, configure the processing circuitry to cause operations that: identify an on-Earth location of a terrestrial terminal, the terrestrial terminal to establish a data link via a satellite non-terrestrial network (NTN); identify respective times that satellite vehicles in the satellite NTN are within line-of-sight to provide network connectivity for the data link to the terrestrial terminal at the on-Earth location; evaluate (e.g., determine or identify) payload capabilities of the satellite vehicles to perform varying types of connectivity and data processing within the satellite NTN; generate data link reservations for the satellite vehicles to provide the network connectivity for the data link with the terrestrial terminal during the respective times, based on respective payload capabilities of respective satellite vehicles of the satellite NTN; and communicate the data link reservations to the satellite vehicles, the data link reservations to cause the respective satellite vehicles to reserve a portion of an uplink and a downlink of the satellite NTN to provide the network connectivity to the terrestrial terminal at the on-Earth location during the respective times.

In Example 12, the subject matter of Example 11 optionally includes wherein the respective payload capabilities of the satellite vehicles include hardware, firmware, and software configurations that vary among some of the satellite vehicles, and wherein the satellite vehicles are in a same orbit to provide coverage at varying times from the respective satellite vehicles to the on-Earth location.

In Example 13, the subject matter of any one or more of Examples 11-12 optionally include wherein the data link reservations cause the satellite NTN to reserve resources for the data link using inter-satellite links among multiple satellites, the multiple satellites provided by one or more constellations of satellite vehicles in one or more low-earth orbit orbital bands.

In Example 14, the subject matter of any one or more of Examples 11-13 optionally includes wherein the data link reservations cause the satellite NTN to reserve resources for the data link using satellite-to-earth links with one or more ground stations.

In Example 15, the subject matter of any one or more of Examples 11-14 optionally include wherein the network connectivity to the terrestrial terminal is provided with a direct attachment to a user equipment, in accordance with one or more frequency bands defined by or incorporated into a Fifth Generation (5G) Non-Terrestrial Network (NTN) network specification (e.g., 3GPP TS 38.821, Release 16; TS 38.863, Release 17; 3GPP TS 23.501, Release 15 and thereafter; TS 23.700-01, Release 19, etc.) operating in a frequency division duplex (FDD) mode.

In Example 16, the subject matter of any one or more of Examples 11-15 optionally include wherein the instructions are further to configure the processing circuitry to cause operations that identify communication exclusion or coordination restrictions applicable to the on-Earth location, and wherein the data link reservations are to configure the uplink and the downlink of the satellite NTN to comply with the communication exclusion or coordination restrictions.

In Example 17, the subject matter of Example 16 optionally includes wherein the communication exclusion or coordination restrictions define one or more mitigations for transmissions from the satellite NTN to the on-Earth location, the one or more mitigations provided from: spot beam control, frequency change, or beam steering.

In Example 18, the subject matter of any one or more of Examples 11-17 optionally include wherein the instructions are further to configure the processing circuitry to cause operations that use a trained artificial intelligence model to determine characteristics of the data link reservations for the respective satellite vehicles.

In Example 19, the subject matter of any one or more of Examples 11-18 optionally include wherein the instructions are further to configure the processing circuitry to cause operations that use a trained artificial intelligence model to perform real-time adjustments of the uplink and the downlink, during use of the network connectivity to the terrestrial terminal for the respective times.

In Example 20, the subject matter of any one or more of Examples 11-19 optionally include wherein the computing device is located on-Earth or located in a satellite vehicle, and wherein the data link reservations are communicated from the computing device to the respective satellite vehicles in connection with telemetry tracking and command (TTC) information for the satellite NTN.

Example 21 is a device, comprising: processing circuitry; and a memory device including instructions embodied thereon, wherein the instructions, which when executed by the processing circuitry, configure the processing circuitry to perform operations for mission planning and scheduling for non-terrestrial network connections, in accordance with any of Examples 1 to 20 or the other techniques discussed herein.

Example 22 is a method, comprising a plurality of operations executed with a processor and memory of a device, to perform mission planning and scheduling for non-terrestrial network connections, in accordance with any of Examples 1 to 20 or the other techniques discussed herein.

Example 23 is a non-transitory device-readable storage medium including instructions, wherein the instructions, when executed by a processing circuitry of a device, cause the processing circuitry to perform mission planning and scheduling for non-terrestrial network connections, in accordance with any of Examples 1 to 20 or the other techniques discussed herein.

Example 24 is an apparatus, comprising respective means for performing mission planning and scheduling for non-terrestrial network connections, in accordance with any of Examples 1 to 20 or the other techniques discussed herein.

Example 25 is a satellite vehicle comprising circuitry for performing mission planning and scheduling for non-terrestrial network connections, in accordance with any of Examples 1 to 20 or the other techniques discussed herein.

Example 26 is a user equipment communications device comprising circuitry for connecting with a non-terrestrial network adapted for performing mission planning and scheduling, in accordance with any of Examples 1 to 20 or the other techniques discussed herein.

Example 27 is a 5G communication network, comprising network equipment configured for connecting with a non-terrestrial network adapted for performing mission planning and scheduling, using an exclusion, coordination, or inclusion zone, in accordance with any of Examples 1 to 20 or the other techniques discussed herein.

Example 28 is a network comprising respective devices and device communication mediums for performing any of Examples 1 to 20 or any of the operations or techniques discussed herein.

Example 29 is a system comprising respective components arranged or configured to perform any of Examples 1 to 20 or any of the operations or techniques discussed herein.

Example 30 is a method, performed using circuitry of a computing device, as arranged or configured to perform any of Examples 1 to 20 or any of the operations or techniques discussed herein.

In the examples above, many references were provided to low-earth orbit (LEO) satellites and constellations. However, it will be understood that the examples above are also relevant to many forms of middle-earth orbit satellites and constellations, geosynchronous orbit satellites and constellations, and other high altitude communication platforms such as balloons. Thus, it will be understood that the techniques discussed for LEO network settings are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually, and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. A method, comprising:
identifying an on-Earth location of a terrestrial terminal, the terrestrial terminal to establish a data link via a satellite non-terrestrial network (NTN);
identifying respective times that satellite vehicles in the satellite NTN are within line-of-sight to provide network connectivity for the data link to the terrestrial terminal at the on-Earth location;
evaluating payload capabilities of the satellite vehicles to perform varying types of connectivity and data processing within the satellite NTN;
generating data link reservations for the satellite vehicles to provide the network connectivity for the data link with the terrestrial terminal during the respective times, based on respective payload capabilities of respective satellite vehicles of the satellite NTN; and
communicating the data link reservations to the satellite vehicles, to cause the respective satellite vehicles to reserve a portion of an uplink and a downlink of the satellite NTN to provide the network connectivity to the terrestrial terminal at the on-Earth location during the respective times.

2. The method of claim 1, wherein the respective payload capabilities of the satellite vehicles include hardware, firmware, and software configurations that vary among some of the satellite vehicles, and wherein the satellite vehicles are in a same orbit to provide coverage at varying times from the respective satellite vehicles to the on-Earth location.

3. The method of claim 1, wherein the data link reservations cause the satellite NTN to reserve resources for the data link based on:
using inter-satellite links among multiple satellites, the multiple satellites operating within one or more constellations of satellite vehicles in one or more low-earth orbit orbital bands; or
using satellite-to-earth links with one or more ground stations.

4. The method of claim 1, wherein the network connectivity to the terrestrial terminal is provided with a direct attachment to a user equipment, in accordance with one or more frequency bands defined by a Fifth Generation (5G) Non-Terrestrial Network (NTN) network specification operating in a frequency division duplex (FDD) mode.

5. The method of claim 1, further comprising:
identifying communication exclusion or coordination restrictions applicable to the on-Earth location, and wherein the data link reservations configure the uplink and the downlink of the satellite NTN to comply with the communication exclusion or coordination restrictions.

6. The method of claim 5, wherein the communication exclusion or coordination restrictions define one or more mitigations for transmissions from the satellite NTN to the on-Earth location, the one or more mitigations provided from: spot beam control, frequency change, or beam steering.

7. The method of claim 1, further comprising using a trained artificial intelligence model to:
determine characteristics of the data link reservations for the respective satellite vehicles; or
perform real-time adjustments of the uplink and the downlink, during use of the network connectivity to the terrestrial terminal for the respective times.

8. At least one non-transitory machine-readable medium comprising instructions, wherein the instructions, when executed by processing circuitry of a computing system, cause the processing circuitry to perform operations that:
identify an on-Earth location of a terrestrial terminal, the terrestrial terminal to establish a data link via a satellite non-terrestrial network (NTN);
identify respective times that satellite vehicles in the satellite NTN are within line-of-sight to provide network connectivity for the data link to the terrestrial terminal at the on-Earth location;
evaluate payload capabilities of the satellite vehicles to perform varying types of connectivity and data processing within the satellite NTN;
generate data link reservations for the satellite vehicles to provide the network connectivity for the data link with the terrestrial terminal during the respective times, based on respective payload capabilities of respective satellite vehicles of the satellite NTN; and
communicate the data link reservations to the satellite vehicles, to cause the respective satellite vehicles to reserve a portion of an uplink and a downlink of the satellite NTN to provide the network connectivity to the terrestrial terminal at the on-Earth location during the respective times.

9. The non-transitory machine-readable medium of claim 8, wherein the respective payload capabilities of the satellite vehicles include hardware, firmware, and software configurations that vary among some of the satellite vehicles, and wherein the satellite vehicles are in a same orbit to provide coverage at varying times from the respective satellite vehicles to the on-Earth location.

10. The non-transitory machine-readable medium of claim 8, wherein the data link reservations cause the satellite NTN to reserve resources for the data link based on:
use of inter-satellite links among multiple satellites, the multiple satellites operating within one or more constellations of satellite vehicles in one or more low-earth orbit orbital bands; or
use of satellite-to-earth links with one or more ground stations.

11. The non-transitory machine-readable medium of claim 8, wherein the instructions, when executed by processing circuitry of the computing system, cause the processing circuitry to perform operations that:
identify communication exclusion or coordination restrictions applicable to the on-Earth location, and wherein the data link reservations are to configure the uplink and the downlink of the satellite NTN to comply with the communication exclusion or coordination restrictions; and
wherein the communication exclusion or coordination restrictions are to define one or more mitigations for transmissions from the satellite NTN to the on-Earth location, the one or more mitigations provided from: spot beam control, frequency change, or beam steering.

12. The non-transitory machine-readable medium of claim 8, wherein the operations are performed by a computing system located on-Earth or located in a satellite vehicle, and wherein the data link reservations are to be communicated from the computing system to the respective satellite vehicles in connection with telemetry tracking and command (TTC) information provided to the satellite NTN.

13. A computing device, comprising:
processing circuitry; and
at least one machine-readable medium including instructions embodied thereon, wherein the instructions, when executed by the processing circuitry, configure the processing circuitry to cause operations that:
identify an on-Earth location of a terrestrial terminal, the terrestrial terminal to establish a data link via a satellite non-terrestrial network (NTN);
identify respective times that satellite vehicles in the satellite NTN are within line-of-sight to provide network connectivity for the data link to the terrestrial terminal at the on-Earth location;
evaluate payload capabilities of the satellite vehicles to perform varying types of connectivity and data processing within the satellite NTN;
generate data link reservations for the satellite vehicles to provide the network connectivity for the data link with the terrestrial terminal during the respective times, based on respective payload capabilities of respective satellite vehicles of the satellite NTN; and
communicate the data link reservations to the satellite vehicles, the data link reservations to cause the respective satellite vehicles to reserve a portion of an uplink and a downlink of the satellite NTN to provide the network connectivity to the terrestrial terminal at the on-Earth location for the respective times.

14. The computing device of claim 13, wherein the respective payload capabilities of the satellite vehicles include hardware, firmware, and software configurations that vary among some of the satellite vehicles, and wherein the satellite vehicles are in a same orbit to provide coverage at varying times from the respective satellite vehicles to the on-Earth location.

15. The computing device of claim 13, wherein the data link reservations are to cause the satellite NTN to reserve resources for the data link based on:
use of inter-satellite links among multiple satellites, the multiple satellites provided within one or more constellations of satellite vehicles in one or more low-earth orbit orbital bands; or
use of satellite-to-earth links with one or more ground stations.

16. The computing device of claim 13, wherein the network connectivity to the terrestrial terminal includes a direct attachment to a user equipment, in accordance with one or more frequency bands defined by a Fifth Generation (5G) Non-Terrestrial Network (NTN) network specification operating in a frequency division duplex (FDD) mode.

17. The computing device of claim 13, wherein the instructions are further to configure the processing circuitry to cause operations that identify communication exclusion or coordination restrictions applicable to the on-Earth location, and wherein the data link reservations are to configure the uplink and the downlink of the satellite NTN to comply with the communication exclusion or coordination restrictions.

18. The computing device of claim 17, wherein the communication exclusion or coordination restrictions define one or more mitigations for transmissions from the satellite NTN to the on-Earth location, the one or more mitigations provided from: spot beam control, frequency change, or beam steering.

19. The computing device of claim 13, wherein the instructions are further to configure the processing circuitry to cause operations that use a trained artificial intelligence model to:
determine characteristics of the data link reservations for the respective satellite vehicles; or
perform real-time adjustments of the uplink and the downlink, during use of the network connectivity to the terrestrial terminal for the respective times.

20. The computing device of claim 13, wherein the computing device is located on-Earth or located in a satellite vehicle, and wherein the data link reservations are to be communicated from the computing device to the respective satellite vehicles in connection with telemetry tracking and command (TTC) information for the satellite NTN.
